(19) United States
(12) Patent Application Publication
(10) Pub. No.: US 2026/0129528 A1
(43) Pub. Date: May 7, 2026

(54) SIGNALING TO TRANSFER TARGET WAKE TIME AGREEMENTS BETWEEN LINKS WITHIN OR ACROSS MULTI-LINK DEVICES

(71) Applicant: Cisco Technology, Inc., San Jose, CA (US)

(72) Inventors: Binita Gupta, San Diego, CA (US); Brian D. Hart, Sunnyvale, CA (US); Malcolm M. Smith, Richardson, TX (US); Indermeet Singh Gandhi, San Jose, CA (US)

(21) Appl. No.: 19/189,982

(22) Filed: Apr. 25, 2025

Related U.S. Application Data
(60) Provisional application No. 63/715,521, filed on Nov. 2, 2024.

(51) Int. Cl. H04W 36/00; H04W 76/20

(52) U.S. Cl. CPC H04W 36/0072; H04W 36/008357; H04W 76/20

(57) ABSTRACT

Embodiments for enabling a non-access point (non-AP) multi-link device (MLD) to transfer one or more existing Target Wake Time (TWT) agreements to a new link either for an AP MLD or across AP MLDs. In at least one embodiment, a computer-implemented method is provided that includes obtaining, from a non-AP MLD that is seeking to roam from a first AP MLD to a second AP MLD, a request to transfer one or more TWT agreements from one or more wireless links of the first AP MLD to one or more wireless links of the second AP MLD; determining whether any of the one or more TWT agreements are accepted for any wireless links of the second AP MLD; and providing a response to the non-AP MLD indicating whether any of the TWT agreements are accepted for the wireless links of the second AP MLD.

### PRIORITY CLAIM

This application claims the benefit of priority under 35 U.S.C. § 119 to U.S. Provisional Application No. 63/715,521, filed Nov. 2, 2024, the entirety of which is incorporated herein by reference.

### TECHNICAL FIELD

The present disclosure relates to wireless networking.

### BACKGROUND

Networking architectures have grown increasingly complex in communications environments, particularly wireless networking environments. For wireless local area networks, Institute of Electrical and Electronics Engineers (IEEE) 802.11be (Wi-Fi® 7) defines various features to facilitate Multi-Link Operation (MLO) for Multi-Link Devices (MLDs) that are capable of associating and simultaneously exchange data traffic on multiple Radio Frequency (RF) bands or ‘links’.

### BRIEF DESCRIPTION OF THE DRAWINGS

FIG. 1 is a block diagram of a system that may be implemented to facilitate techniques for transferring Target Wake Time (TWT) agreements between links with a current access point (AP) Multi-Link Device (MLD) or between AP MLDs within a Seamless Mobility Domain (SMD), according to an example embodiment.

FIG. 2 is a call flow diagram depicting techniques for transferring TWT agreements as part of link reconfiguration signaling, according to an example embodiment.

FIG. 3 is a call flow diagram depicting techniques for TWT agreement setup with a current AP MLD as part of link reconfiguration signaling, according to an example embodiment.

FIGS. 4A, 4B, and 4C are diagrams showing example formats for signaling one or more TWT elements, TWT agreement identifiers, or TWT agreement types to facilitate transferring one or more TWT agreements, according to various example embodiments.

FIGS. 4D-1 and 4D-2 are diagrams showing example formats for signaling one or more TWT agreement identifiers or TWT agreement types to facilitate transferring one or more TWT agreements, according to various example embodiments.

FIG. 5 is a flowchart depicting a method according to an example embodiment.

FIGS. 6 and 7 are call flow diagrams depicting techniques for TWT agreement transfer when a non-AP MLD roams from one AP MLD to another AP MLD within a Seamless Mobility Domain (SMD), according to an example embodiment.

FIG. 8 is a flowchart depicting another method according to an example embodiment.

FIG. 9 is a flowchart depicting another method according to an example embodiment.

FIG. 10 is a hardware block diagram of device configured to perform functions associated with operations discussed in connection with embodiments herein.

### DETAILED DESCRIPTION

### Overview

Innovations in wireless access points (APs) and devices for wireless local area network (WLAN) technologies, such as Institute of Electrical and Electronics Engineers (IEEE) 802.11 (e.g., Wi-Fi®) technologies, have led to the development of Multi-Link Devices (MLDs) that are capable of Multi-Link Operation (MLO), as prescribed by IEEE 802.11be (and marketed as Wi-Fi® 7)).

For MLO, MLDs can associate and simultaneously exchange data traffic on multiple Radio Frequency (RF) bands, such as 2.4 Gigahertz (GHz), 5 GHz, and/or 6 GHz bands. MLDs can include AP MLDs and non-AP MLDs. Non-AP MLDs are often referred to as MLD client devices, MLD-STAs (STA=abbreviation of station), or STA MLDs; the term “client” can also refer to a STA MLD.

An AP MLD can be configured with multiple RF transceivers and baseband processors/Media Access Control (MAC) processors to facilitate MLO. Similarly, a non-AP MLD can be configured with multiple RF transceivers and baseband processors/Media Access Control (MAC) processors to facilitate MLO. As referred to herein, the terms ‘link’, ‘wireless link’, and variations thereof can refer to a wireless connection through which a station (of a non-AP MLD) can wirelessly connect to/access the wireless connection provided by an AP (of an AP MLD). Each link can use a different channel of a certain bandwidth.

A mechanism is presented herein to enable a non-AP MLD to be able to transfer one or more of its existing Target Wake Time (TWT) agreements to a new link when it switches an existing link to the new link, either within an MLD or across MLDs, or deletes a link to avoid any disruption to ongoing services/flows associated with those TWT schedules.

In at least one embodiment, a method is provided that may include: obtaining, from a non-access point multi-link device (non-AP MLD) that is seeking to roam from a first access point multi-link device (AP MLD) to a second AP MLD, a request to transfer one or more Target Wake Time (TWT) agreements for the non-AP MLD from one or more wireless links of the first AP MLD to one or more wireless links of the second AP MLD; determining whether any of the one or more TWT agreements are accepted for the one or more wireless links of the second AP MLD; and providing a response to the non-AP MLD indicating whether any of the one or more TWT agreements are accepted for the one or more wireless links of the second AP MLD.

In at least one embodiment, a method is provided that may include: transmitting, by a non-access point multi-link device (non-AP MLD) a request to transfer one or more Target Wake Time (TWT) agreements for the non-AP MLD from one or more wireless links of a first access point multi-link device (AP MLD) to one or more wireless links of a second AP MLD; and obtaining a response indicating whether any of the one or more TWT agreements are accepted for the one or more wireless links of the second AP MLD.

### Example Embodiments

In a wireless local area network (WLAN) or Wi-Fi® network, one or more wireless APs provide wireless Radio Frequency (RF) coverage over which one or more wireless devices (e.g., phones, wearable devices, tablets, etc.) can connect to the APs in order to connect to one or more data networks (e.g., the public Internet, an enterprise network operated by an enterprise entity (e.g., a business, institution, university, etc.)), and/or the like.

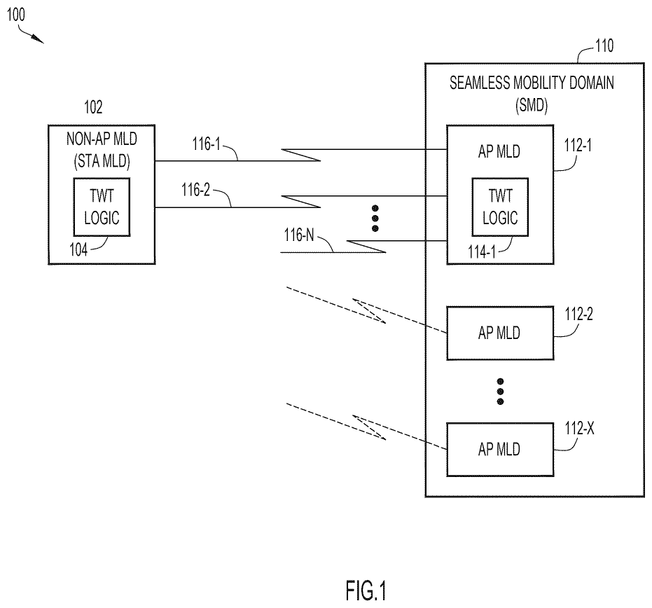

FIG. 1 is a block diagram of a system 100 that may be implemented to facilitate techniques for transferring Target Wake (or Wake-up) Time (TWT) agreements for a non-access point (non-AP) MLD between links with a current AP Multi-Link Device (MLD) or between AP MLDs within a Seamless Mobility Domain (SMD), according to an example embodiment.

In at least one embodiment, system 100 may include a WLAN (e.g., a Wi-Fi® network) that includes one or more non-AP MLDs (STA MLDs), such as a non-AP MLD 102, also referred to herein as client/client device that is capable of MLO. Non-AP MLD 102 may be configured with TWT logic 104 in order to facilitate transferring TWT agreements in accordance with embodiments herein.

Also shown in system 100 are a number of wireless APs that are capable of MLO, shown in FIG. 1 as an AP MLD 112-1, an AP MLD 112-2, through an AP MLD 112-X for an ‘X’ number of AP MLDs. Each AP MLD can be configured with TWT logic in order to facilitate transferring TWT agreements for a non-AP MLD, such as non-AP MLD 102 in accordance with embodiments herein. For example, TWT logic 114-1 is illustrated as being configured for AP MLD 112-1. Although not shown in FIG. 1, consider that AP MLD 112-2 through AP MLD 112-X are similarly configured with TWT logic in accordance with embodiments herein.

AP MLD 112-1, 112-2, through AP MLD 112-X may be configured as Seamless Mobility Domain (SMD), such as an SMD 110, as shown in FIG. 1. An SMD is a mobility domain for seamless roaming and consists of a set of AP MLDs within the same Extended Service Set (ESS) that support seamless roaming for non-AP MLDs between themselves and that are identified by an SMD MAC address. An ESS can have one or more SMDs configured covering its AP MLDs.

AP MLD 112-1, 112-2, through AP MLD 112-X can interface with each other via a Distribution System (DS). A DS may be considered any AP-to-AP link that is visible at Layer 2 (meaning Media Access Control (MAC) addresses are visible). Thus, a DS can consist of a mesh link between 2 AP radios or, more commonly, a wired Ethernet (802.3) link between AP MLDs. To accommodate communication on such a DS, 802.11 designed 802.11F with a recommendation for a standard referred to as Inter AP Protocol (IAPP), through which AP MLDs can encapsulate in the other medium (e.g., 802.3) 802.11-related information to be exchanged.

AP MLD 112-1 and any other AP MLDs discussed herein, such as AP MLD 112-2, etc. can provide a number of wireless links to facilitate MLO features in accordance with embodiments herein. As shown in FIG. 1, a number of wireless links, such as a wireless link 116-1, a wireless link 116-2, through a wireless link 116-N for an ‘N’ number of wireless links can be provided by AP MLD 112-1 to support multiple wireless connections involving clients/STA MLDs, such as non-AP MLD 102.

For MLO, MLDs can associate and simultaneously exchange data/traffic on multiple channels across multiple RF bands, such as 2.4 Gigahertz (GHz), 5 GHz, and/or 6 GHz bands. Thus, as shown in FIG. 1, the AP MLD 112-1 and the non-AP MLD 102 can communicate across multiple wireless links (links) 116-1 to 116-N simultaneously.

Current WLAN/Wi-Fi standards and/or amendments, such as IEEE 802.11be (and marketed as Wi-Fi 7), define various multi-link features for MLO. The IEEE 802.11be amendment has defined a multi-link (ML) reconfiguration procedure that can be used to add and delete links to the existing ML setup of a non-AP MLD. A non-AP MLD (e.g., non-AP MLD 102) can use this procedure to switch one of its links to another link by specifying both delete link and add link in the same Link Reconfiguration Request message. For example, a non-AP MLD with 2.4 GHz and 5 GHz links established can perform delete link (for 5 GHz) and add link (for 6 GHz) in the same request frame to switch its 5 GHz link to a 6 GHz link. This can be desirable if the non-AP MLD wants the delete+add operation to be performed together.

In such a link switch operation, it is desirable for the non-AP MLD to transfer its existing Target Wake Time (TWT) agreements established on the current link (such as broadcast TWT (bTWT) agreement(s), individual TWT (iTWT) agreement(s), and/or restricted TWT (rTWT) agreement(s)) to the switched link, so that the non-AP MLD can continue to service existing traffic flows related to those TWT agreements. The alternative is for the non-AP MLD to negotiate/establish those TWT agreements again on the new link after the link has been switched, which may result in service disruption or a failure to establish those TWT agreements on the new link because the negotiation could fail for the new link (e.g., to avoid any additional overhead plus any potential disruption to Quality of Service (QoS) treatment for flow(s) that are carried over for corresponding TWT(s)).

Embodiments herein provide for a non-AP MLD to be able to transfer its existing TWT agreements to a newly switched link, to avoid any disruption to ongoing services/flows. It is desirable to achieve transfer of TWT agreements when a switch link operation happens within an AP MLD and also when a non-AP MLD switches a link across AP MLDs such as from one AP to another AP MLD within a SMD, such as for scenario in which non-AP MLD 102 seeks to roam from AP MLD 112-1 to another AP MLD, such as AP MLD 112-2, within the SMD 110.

There are also cases where a non-AP MLD may want to transfer some (or all) of its existing TWT agreements from other link(s) to a newly added link even when not switching a link. This could be because the newly added link provides better conditions (e.g., less congested and lightly loaded) and hence can better serve high Quality of Service (QoS) flows being served as part of those TWT agreements (specially for restricted TWT). Also, when deleting a link, a non-AP MLD may want to transfer some (or all) of its existing TWT agreements from that link to another existing setup link, even when not adding a link. This could be because STA still wants to keep those TWT agreements to continue serving high QoS traffic flows based on those TWT agreements (e.g., for rTWT flows). Thus, mechanisms are defined through embodiments herein to enable a non-AP MLD to be able transfer TWT agreements across links when adding a link and when deleting a link. It may also be desirable to achieve transfer of TWT agreements between links adding a link or deleting a link within an AP MLD and also when a non-AP MLD roams across AP MLDs within an SMD (from one AP MLD to another AP MLD within a SMD), such as for scenario in which non-AP MLD 102 seeks to roam from AP MLD 112-1 to another AP MLD, such as AP MLD 112-2, within the SMD 110.

Additionally, a non-AP MLD may want to establish new TWT agreements (e.g., iTWT, bTWT, and/or rTWT agreements) when adding a link or switching a link within its current ML setup. This can provide optimal operation to set up one or more desired TWT agreements by a non-AP MLD along with a link reconfiguration operation, instead of causing the non-AP MLD to perform TWT agreements set up separately. Thus, embodiments herein may provide the ability to achieve setting up new TWT agreements when adding a new link with a current AP MLD or during the roaming scenario when adding links with a target AP MLD as part of roaming.

Two approaches are provided herein for transferring and/or establishing one or more new TWT agreements.

For a first approach (Approach 1), a non-AP MLD, such as non-AP MLD 102, can communicate/signal to an AP MLD (a current AP or a target AP, such as for a roaming scenario), one or more corresponding TWT elements or one or more corresponding TWT agreement identifiers (IDs) (also referred to herein as TWT IDs) for one or more corresponding TWT agreements that are requested to be transferred to and/or established for a link. For indicating TWT IDs, the non-AP MLD may provide a list of TWT Identifiers (for example iTWT identifiers, bTWT identifiers and/or rTWT identifiers) that it wants to transfer to an added link or transfer from a deleted link to other setup links.

For a second approach (Approach 2), a non-AP MLD, such as non-AP MLD 102, can communicate/signal to an AP MLD (a current AP or a target AP, such as for a roaming scenario) one or more TWT types (e.g., bTWT type, rTWT type, and/or iTWT type) to be transferred to and/or established for a link.

With regard to transferring TWT agreement(s) to a new link, a non-AP MLD, such as non-AP MLD 102, may decide to transfer all or a subset of the TWT agreements to the new link.

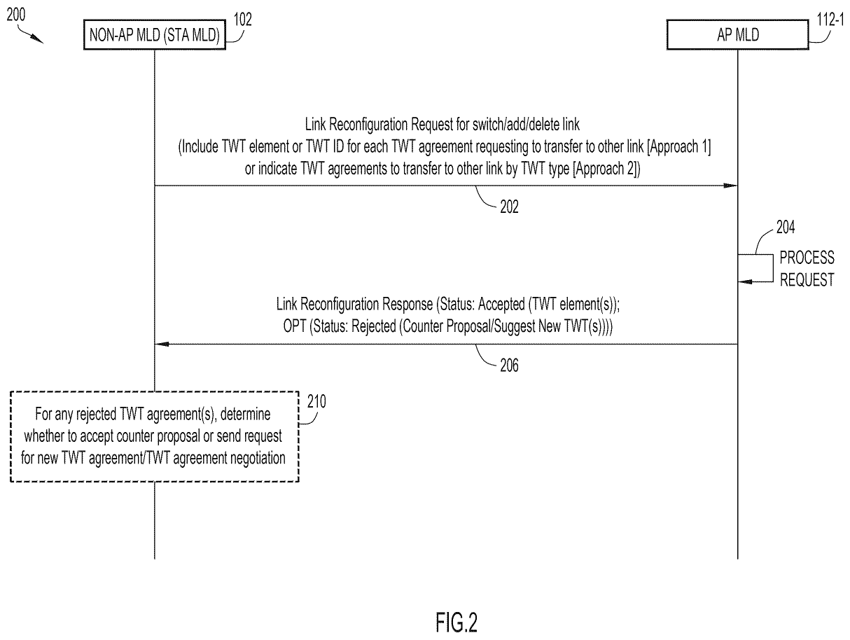

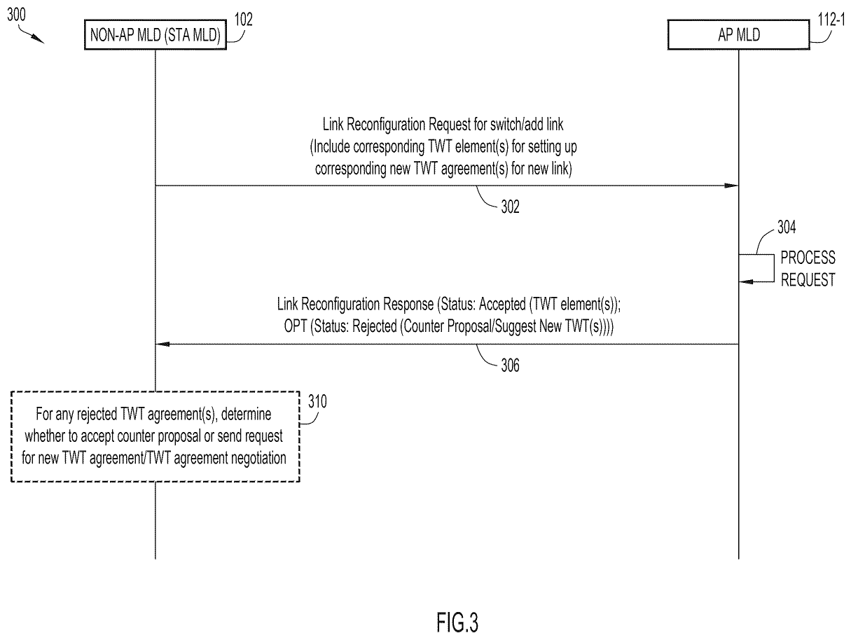

Reference is now made to FIGS. 2 and 3. FIG. 2 illustrates a call flow or sequence diagram 200 for facilitating TWT agreement transfer across links within an AP MLD, according to an example embodiment, and FIG. 3 illustrates a call flow or sequence diagram 300 for facilitating a new TWT agreement setup during an Add Link or Switch Link operation with the AP MLD, according to an example embodiment. FIG. 2 and FIG. 3 each include non-AP MLD 102 and AP MLD 112-1.

With reference to FIG. 2, the following operations are defined (where STA also refers to a non-AP MLD, such as non-AP MLD 102):
For a Switch link case: the STA can indicate which TWT agreements and/or which type of TWT agreements (iTWT, bTWT and/or rTWT) to transfer to a new link.
For an Add Link case: the STA can indicate any existing TWT agreements and/or type of TWT agreements to transfer to the newly added link.
For a Delete link case: STA can indicate any TWT agreements and/or type of TWT agreements to transfer from the deleted link to another existing setup link.

As shown in FIG. 2, the non-AP MLD 102 can signal a Link Reconfiguration Request frame to the AP MLD 112-1, as shown at 202, that can be enhanced in accordance with embodiments herein using the first approach or the second approach in order to facilitate transferring one or more TWT agreements to a link. Under either approach, the AP MLD 112-1 can process the request and make a decision as to whether the one or more TWT agreements can be accepted for the link, as generally shown at 204, and can signal a Link Reconfiguration Response frame to the non-AP MLD 102, as generally shown at 206, that includes various elements indicating the decision regarding the request to transfer the TWT agreement(s) to the link, as discussed in further detail herein, below.

In one example, to transfer TWT agreement(s) from a current link to be deleted to a newly added link (for a switch link case), the non-AP MLD 102 can, for the first approach, signal the Link Reconfiguration Request frame to the AP MLD 112-1 that includes one or more corresponding TWT elements for one or more corresponding TWT agreements requested to be transferred in the STA Profile field of the per-station (Per-STA) Profile subelement included for the add link operation corresponding to the new link (in the Link Reconfiguration Request frame).

If signaling TWT ID(s) in the Link Reconfiguration Request frame, the non-AP MLD 102 can include the TWT ID(s) for the TWT agreement(s) that are sought to be transferred to the new link in the STA Info field of the Per-STA Profile subelement included for the add link operation. [The 802.11be standard uses the “Info” label for certain fields; it is to be understood that this is an abbreviation for ‘information’.]

In some embodiments, the non-AP MLD 102 can also indicate in the STA Control and/or STA Info field (of the Per-STA Profile subelement) that it is providing one or more corresponding TWT elements or is providing one or more corresponding TWT IDs for the one or more corresponding TWT agreements that it wants to be transferred and which other setup link(s) it wants those TWT agreements to be transferred.

Various enhancements to Link Reconfiguration Request frame signaling that may be used for indicating TWT element(s) or indicating TWT ID(s) via the Per-STA Profile subelement for transferring to another link are discussed in further detail herein, below, with reference to FIGS. 4A, 4B, 4C, 4D-1, and 4D-2.

The non-AP MLD 102 can decide to transfer all or a subset of the TWT agreements to the new link. Thus, under the first approach in at least one embodiment, in the STA Profile field for the add link operation, the non-AP MLD 102 can include one or more TWT elements that indicate either all existing TWT agreements or a subset of TWT agreements that are set up on the link being deleted and being switched to a new link within the Link Reconfiguration Request frame at 202.

In another embodiment under the first approach, in the STA Info field for the add link operation, the non-AP MLD 102 can include one or more TWT IDs that indicate all existing TWT agreements or a subset of TWT agreements that are set up on the link being deleted and being switched to a new link within the Link Reconfiguration Request frame at 202. For example, the non-AP MLD 102 may signal at 202 to transfer all of its current TWT agreements, including any broadcast TWT, individual TWT and/or restricted TWT agreements or a subset of those agreements (such as only transferring restricted TWT agreements, etc.) from the link to be deleted to the new link to be added.

Similarly, for a pure add link operation (and not a switch link case), in the Link Reconfiguration Request frame under the first approach, the non-AP MLD 102 can include in the STA Profile field of a Per-STA Profile subelement of an add link operation the one or more corresponding TWT elements corresponding to the one or more TWT agreements or can include in the STA Info field of the Per-STA Profile subelement of the add link operation the one or more TWT IDs corresponding to the one or more TWT agreements that it wants to transfer to that added link. Similarly, for a pure delete link operation (where the deleted link is not getting switched to another link), in the Link Reconfiguration Request frame, the non-AP MLD 102 can include a Per-STA Profile subelement for the delete link operation and in the STA Profile include one or more corresponding TWT elements corresponding to the one or more TWT agreements (set up on that to be deleted link) or can include in the STA Info field of the Per-STA Profile subelement of the add link operation the TWT IDs corresponding to the one or more TWT agreements that it wants to transfer to other setup links for the non-AP MLD. Similarly, as noted above, the non-AP MLD can also indicate in the STA Control and/or STA Info field (of the Per-STA Profile subelement) that it is providing corresponding TWT elements for the corresponding TWT agreements or the corresponding TWT IDs that it wants to be transferred and which other setup link(s) it wants those TWT agreements to be transferred.

Thus, Approach 1 involves the non-AP MLD 102 explicitly including corresponding TWT elements or including corresponding TWT IDs for the corresponding TWT agreements that it wants to be transferred to the newly switched link.

In another embodiment, under the second approach (Approach 2), if a non-AP MLD, such as non-AP MLD 102, wants to transfer all of its existing TWT agreements for each type of TWT agreement (i.e., broadcast TWT, individual TWT and/or restricted TWT), the non-AP MLD 102 can simply signal TWT agreement type indication(s) to the AP MLD 112-1 within the Link Reconfiguration Request frame signaling at 202 for each TWT agreement type sought to be transferred to a link, instead of including one or more TWT elements providing TWT schedule information or one or TWT IDs for already established TWT agreements, for which the AP MLD 112-1 already has all the information. This approach may be more optimal than the first approach, as it may minimize the size of the request frame for the delete+add link operation when switching a link.

The signaling under the second approach can also be utilized for the case of a pure add link operation if the non-AP MLD 102 wants to transfer all its TWT agreements of specific type from one or more existing link to the added link. The non-AP MLD 102 can indicate the links from which it wants to transfer TWT agreements using one or more added Link ID fields in the STA Info field of the Per-STA profile element for the add link operation. Similarly, for a pure delete link operation, a non-AP MLD can indicate which type of TWT agreements it wants to transfer from the deleted links to other setup links and provide Link ID(s) where it wants to transfer those TWT agreements.

In at least one embodiment, the non-AP MLD 202 can include a new conditional field in the STA Info field of the Per-STA Profile element of the Link Reconfiguration Request frame sent at 202 to indicate which types of TWT agreements are requested to be transferred to the newly added link. The new conditional field of the STA Info field that can be used to indicate TWT agreement types is referred to herein as a ‘TWT Transfer Info’ field and is discussed in further detail herein, below, with reference to FIGS. 4A, 4B, 4C, 4D-1, and 4D-2. In at least one embodiment, the TWT Transfer Info field can also be used to indicate TWT IDs (under the first approach) for TWT agreements that are requested to be transferred to the newly added link.

As generally shown at 204, the AP MLD 112-1, upon receiving one or more TWT elements (in the STA Profile field), one or more TWT IDs (in the TWT Transfer Info field), or one or more TWT type indications (in the TWT Transfer Info field) for an add link operation (for both switch link case and pure add link case) that is indicated in the Link Reconfiguration Request frame, will process these TWT elements/TWT IDs/TWT types for establishing TWT agreements on the new link(s) being added as per the existing procedures and rules defined for TWT setup.

The AP MLD 112-1, may not accept all the TWT agreements requested to be transferred to another link (e.g., the requested TWT agreements may conflict with existing TWT agreements of AP MLD or may not be supported by the AP MLD) and the AP MLD 112-1 may accept only a subset of requested TWT agreements on another link In at least one embodiment, for the one or more TWT elements/TWT IDs/TWT types included in the request for which TWT setup is successful, the AP MLD 112-1 will include one or more TWT elements in the STA Profile field of the Per-STA Profile subelement included for the added link(s) in the Link Reconfiguration Response frame sent to the AP MLD at 206, to indicate all successfully established TWT agreement(s) for the switch link and add link operation. It is noted that for scenarios in which corresponding TWT agreements are established on multiple corresponding links, a Per-STA profile subelement can be provided per-link to indicate the TWT element(s) for TWT agreement(s) that were successfully established on each corresponding link.

For the pure delete link operation, the AP MLD 112-1 upon receiving one or more TWT elements (in the STA Profile field), one or more TWT IDs (in the STA Info field), or one or more TWT types (in the TWT Transfer Info field) for the delete link operation in the Link Reconfiguration Request frame, the AP MLD 112-1 will process these TWT elements/TWT IDs/TWT types for establishing TWT agreements on the other setup links being indicated as per the existing procedures and rules defined for TWT setup. For the pure delete link case, the Link Reconfiguration Request frame can also indicate one or more Link IDs (e.g., in the STA Info field) for the link(s) where the non-AP MLD is requesting to transfer/establish the indicated TWT agreements.

For the one or more TWT elements/TWT IDs/TWT types for which TWT setup is successful on other links, the AP MLD 112-1 can indicate such to the non-AP MLD 102 in one of the following ways:
Include a Reconfiguration ML element in the Link Reconfiguration Response frame, which includes one or more Per-STA Profile subelements (one for each link where TWT agreements were successfully set up) with the STA Profile indicating one or more TWT elements corresponding to the TWT agreements that were successfully established on the corresponding setup link; or
Include a Basic ML element, which includes one or more Per-STA Profile subelements (for each link where TWT agreements were successfully set up) with the STA Profile indicating one or more TWT elements corresponding to the TWT agreements that were successfully established on the corresponding setup link.

Thus, embodiments herein (under the first or the second approach) enable a non-AP MLD to transfer its existing TWT agreements from a link that is being deleted to a newly switched link. For the case of a pure add link, this enables a non-AP MLD to transfer its existing corresponding TWT element(s) for corresponding TWT agreement(s) (some or all) on the new added link. For the case of a pure delete link, this enables a non-AP MLD to transfer its corresponding TWT element(s) for corresponding TWT agreement(s) (some or all) from the deleted link to other setup links. For the pure delete link case, the Link Reconfiguration Request frame can indicate one or more Link IDs (e.g., in the STA Info field) for the link(s) where the non-AP MLD is requesting to transfer/establish the indicated TWT agreements.

Moving to FIG. 3, the call flow/sequence diagram 300 illustrates features for facilitating a new TWT agreement setup during an add link or switch link operation with the AP MLD 112-1. For example, in at least one embodiment, as shown at 302, the STA/non-AP MLD 102 can include one or more TWT elements (in the STA Profile field) for one or more TWT agreements corresponding to the added link (in the Reconfiguration ML element in the Link Reconfiguration Request frame) to set up one or more new TWT agreements on the newly added link. The AP MLD 112-1 process the request, as generally shown at 304, and may accept all or a subset of requested TWT agreements for setting up new TWT agreements on the added link; the AP MLD 112-1 can indicate that status to the non-AP MLD 102 in the Link Reconfiguration Response frame sent at 306.

Although the above examples for FIGS. 2 and 3 discuss features in which the AP MLD 112-1 may include corresponding TWT elements for those corresponding TWT agreements that were successfully transferred or newly added to another link, the AP MLD 112-1 may also provide one or more indications to the non-AP MLD 102 via the Link Reconfiguration Response frame that may indicate one or more rejected TWT agreements (that cannot be transferred to another link or that cannot be newly created for the other link) and may provide a corresponding counter proposal TWT element for any corresponding rejected TWT agreements and/or may provide an indication for one or more new TWT agreements (e.g., indicate new TWT element(s) for new TWT agreement(s)) that the AP MLD 112-1 can immediately accept for the other link.

For embodiments in which the AP MLD 112-1 is not able to successfully transfer one or more TWT agreements to another link, the AP MLD 112-1 can, at 206 of FIG. 2 or at 306 of FIG. 3, include in the Link Reconfiguration Response frame a rejection status indicator and may provide a corresponding counter proposal TWT element for any corresponding rejected TWT agreements or may provide an indication for one or more new TWT agreements (e.g., indicate new TWT element(s) for new TWT agreement(s)) that the AP MLD 112-1 can immediately accept for the other link.

In at least one embodiment, a counter proposal/new TWT elements can be indicated in the STA Profile of the Per-STA Profile subelement for the new link that is being set up (in the case of add link or switch link case) or can be indicated in the Per-STA Profile for an existing link to which the TWT agreements transfer was requested (e.g., for delete link case). In at least one embodiment for the counter proposal of one or more TWT elements, the AP MLD 112-1 can set up the ‘TWT Setup Command’ field in the TWT element (as provided in Section 9.4.2.198 of the 802.11be/D7.0 amendment) to indicate one or more suggested proposals. For example, the TWT Setup Command field can be set to ‘Suggest TWT,’ ‘Alternate TWT,’ ‘Dictate TWT,’ or the like, and, for a rejection case, can be set to ‘Reject TWT’ or the like.

In such embodiments, for example, as shown at 210 of FIG. 2 or at 310 of FIG. 3, the non-AP MLD 102 can determine whether to accept a new TWT element for a corresponding counter proposed TWT agreement, whether to send a request to the AP MLD 112-1 for a new TWT agreement (including a TWT element for a new TWT agreement suggested by the AP MLD 112-1), or whether to initiate a new TWT negotiation with the AP MLD 112-1. Based on the determination, the non-AP MLD 102 may trigger one or more requests/signaling towards the AP MLD 112-1 (not shown).

Referring to FIGS. 4A, 4B, 4C, 4D-1 and 4D-2, FIGS. 4A, 4B, 4C, 4D-1, and 4D-2 are diagrams showing example formats for signaling one or more TWT elements, one or more TWT agreement identifiers, or one or more TWT agreement types to facilitate transferring one or more TWT agreements, according to various example embodiments.

The 802.11be/D7.0 amendment, published August 2024, Section 9.4.2.322 defines the Multi-Link element format, which includes a Multi-Link Control field that can be set to a value of ‘2’ to indicate a Reconfiguration Multi-Link element (as defined at Section 9.4.2.322.4) that can be included in a Link Reconfiguration Request frame, as defined at Section 9.6.38.13. The Reconfiguration Response Frame is defined at Section 9.6.38.14. The Multi-Link element further includes a Link Info field that can include a Per-STA profile subelement, which is defined at Section 9.4.2.322.4.

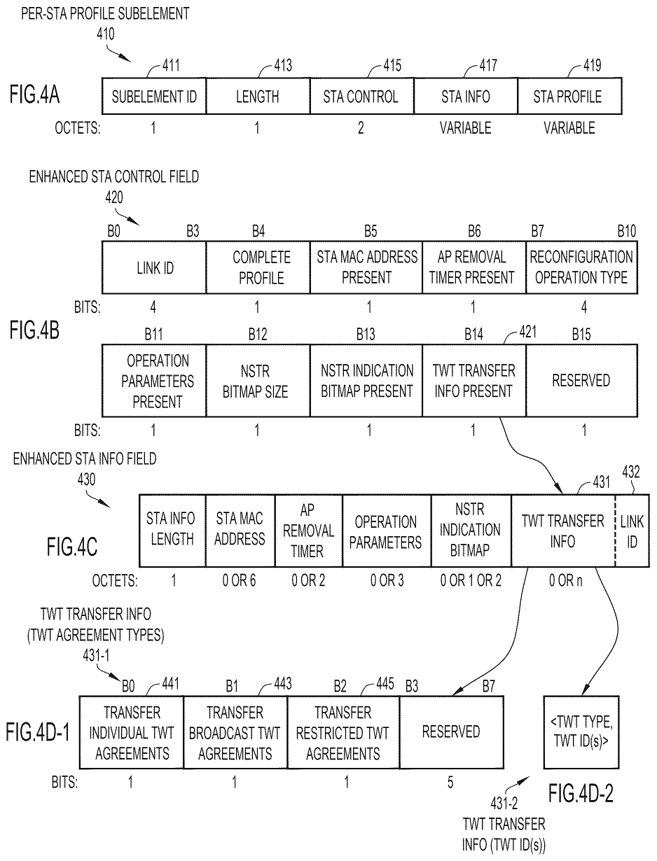

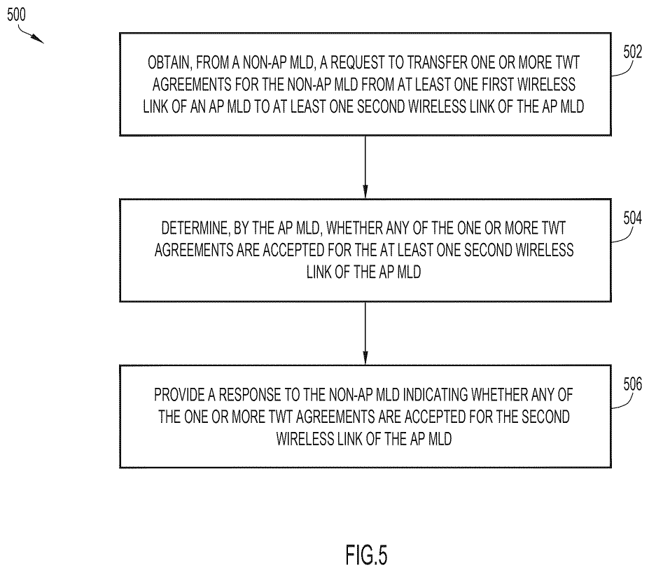

FIG. 4A illustrates the format for a Per-STA Profile subelement 410, as prescribed by the 802.11be/D7.0 amendment. As shown in FIG. 4A, the Per-STA Profile subelement 410 includes a one-octet Subelement ID field 411, a one-octet Length field 413, a two-octet STA Control field 415, a variable octet STA Info field 417, and a variable octet STA Profile field 419.

As discussed herein for embodiments of the first approach in which a non-AP MLD (e.g., non-AP MLD 102) includes one or more corresponding TWT elements for one or more corresponding TWT agreements in a Link Reconfiguration Request that are requested to be transferred to another link (e.g., via switch/add/delete operations), the corresponding TWT elements can be included in the STA Profile field 419.

TWT elements for TWT agreements are defined at least by Section 9.4.2.198 of the 802.11be/D7.0 amendment. During TWT setup operation, one TWT Setup frame with one TWT element (or two TWT elements for indicating a range of TWT parameter values) is exchanged between a non-AP MLD and an AP MLD and sets up one TWT agreement where the agreement is described by one individual TWT sequence or one or more Broadcast/Restricted TWT sequences. All iTWT/rTWT/bTWT agreements include a TWT element including fields such as a Target Wake Time (sometimes referred to as a ‘service start time’ or SST), a Nominal Minimum TWT Wake Duration (e.g., TWT service period in which a client device expects data), and TWT Wake Interval (e.g., how often the duration is repeated). Each of the various types of TWT agreements can include additional TWT fields. For example, individual TWTs can include fields such as TWT Channel, and Link ID Bitmap, among other fields; broadcast TWTs can include fields such as Broadcast TWT Info, among other information. Restricted TWTs were built on top of bTWTs can specify a Traffic Identifiers (TIDs) to which rTWTs are applied along with service periods for those TWTs.

As discussed for embodiments of the first approach in which a non-AP MLD includes one or more corresponding TWT IDs for one or more corresponding TWT agreements in a Link Reconfiguration Request that are requested to be transferred to another link, the TWT IDs can be included in the STA Info field 417, which can be enhanced as discussed below with reference to FIGS. 4C and 4D-2.

In such embodiments of the first approach, a non-AP MLD can include an indication in the STA Control field 415 or in the STA Info field 417 that indicates that one or more TWT elements or one or more TWT IDs are included in a Link Reconfiguration Request. For example, for an embodiment in which corresponding TWT element(s) for corresponding TWT agreement(s) are included in a Link Reconfiguration Request, the non-AP MLD can set the “Complete Profile” subfield to ‘0’ for pure delete link operations (to indicate that a full STA profile is not included, but rather that TWT element(s) are included that need to be transferred) or to ‘1’ for switch/pure add link operations (to indicate that a full STA profile is included for an added link, including corresponding TWT element(s) for corresponding TWT agreement(s) requested to be transferred are included).

As discussed herein for embodiments of the second approach in which a non-AP MLD (e.g., non-AP MLD 102) includes types of TWT agreements in a Link Reconfiguration Request that are requested to be transferred to another link the TWT agreement types (TWT types), the TWT types can be indicated in the STA Info field 417, which can be enhanced as discussed below with reference to FIGS. 4C and 4D-1.

For embodiments herein under the first approach that involves a non-AP MLD signaling TWT IDs for TWT agreements to requested to be transferred to another link or under the second approach that involves a non-AP MLD signaling TWT types of TWT agreements requested to be transferred to another link, an enhanced STA Control field can be provided. FIG. 4B illustrates a format for an enhanced STA control field 420 for the Reconfiguration Multi-Link element that can be provided in accordance with embodiments herein.

As shown in FIG. 4B, the enhanced STA control field 420 can include various fields as prescribed by the 802.11be/D7.0 amendment (e.g., Link ID field, Complete Profile field, and various Present indication fields indicating whether various information is present) and may be enhanced to additionally include a new ‘TWT Transfer Info Present’ field 421. The TWT Transfer Info Present field 421 can be a 1-bit value that can be set to ‘1’ to indicate that TWT transfer information, such as TWT agreement type information or TWT ID information, is present in the Per-STA Profile subelement of a Link Reconfiguration Request received from a given non-AP MLD (e.g., non-AP MLD 102), otherwise, the TWT Transfer Info Present field 421 can be set to ‘0’ if no TWT transfer information is present.

For a scenario in which the ‘TWT Transfer Info Present’ field 421 is set to ‘1’, TWT transfer information can be carried in an enhanced STA Info field 430, as shown in FIG. 4C, that can be enhanced to include a ‘TWT Transfer Info’ field 431. The TWT Transfer Info field may be 0 or n octets. The presence of the TWT Transfer Info field 431 is indicated by the TWT Transfer Info Present field 421, as discussed above.

In some embodiments, such as for roaming scenarios in which a non-AP MLD requests TWT agreements for multiple links to be transferred to a Target AP MLD, multiple instances of the TWT Transfer Info field 431 can be included in the Per-STA Profile subelement 410 in a roaming request sent by the non-AP MLD and the TWT Transfer Info field 431 can be extended to include a Link Identifier (ID) 432 field. For instances in which multiple instances of the TWT Transfer Info field 431 are included in the Per-STA Profile subelement, the link ID field 432 can be set to a wireless link ID of the Serving AP MLD for which the corresponding TWT agreements (that are requested to be transferred to the Target AP MLD) are currently set up on the Serving AP MLD. In at least one embodiment, a wireless link ID can be identified using 4-bits.

Even in embodiments where a non-AP MLD is requesting to transfer TWT agreements to a newly added link or an existing link with the serving AP MLD (based on switch/add/delete link operation during which TWT agreements transfer is requested), the TWT Transfer Info field can include a Link ID field to explicitly indicate the link of the serving AP MLD where the TWT agreements indicated for transfer are established. In one embodiment, the Link ID field may always be included in the TWT Transfer Info field to explicitly indicate the setup link on which the indicated TWT agreements are established. In another embodiment, the Link ID field may be omitted when a non-AP MLD is requesting to perform a switch link or a delete link operation and the TWT agreements requested to be transferred correspond to the link being deleted (for switch link or delete link cases).

The format of TWT agreement(s) requested to be transferred to one or more wireless links (within a given AP MLD or across AP MLDs in a roaming scenario) can vary depending on whether a non-AP MLD signals TWT agreement(s) based on type (requesting to transfer all TWT agreements for each of one or more types of TWT agreements) or based on TWT ID (requesting to transfer one or more TWT agreements for each of one or more types of TWT agreements), as discussed in further detail with reference to FIGS. 4D-1 and 4D-2.

Moving to FIG. 4D-1, FIG. 4D-1 illustrates a first format 431-1 for the ‘TWT Transfer Info’ field 431 that can be used to indicate transfer for all of the TWT agreements of the one or more types of TWT agreements. Separate bits or fields of the first format 431-1 of the TWT Transfer Info field 431 are used to indicate transfer for each type of TWT agreements, which can be defined as follows:
B0 (labeled 441)—Transfer Individual TWT Agreements
B1 (labeled 443)—Transfer broadcast TWT Agreements
B2 (labeled 445)—Transfer restricted TWT Agreements

When an AP MLD, such as AP MLD 112-1, receives the TWT Transfer Info field 431, formatted according to the first format 431-1 as shown in FIG. 4D-1, in a STA Info field (enhanced as shown in FIG. 4C) with one or more bits (from B0, B1, and/or B2) set for transferring TWT agreements, the AP MLD will attempt to establish corresponding TWT agreements which are already established on the link being deleted on to the new link being added. For all the TWT agreements that were successfully established on the new link, the AP MLD will send one or more corresponding TWT elements in the STA Profile field of the Per-STA Profile subelement included for the added link in the Link Reconfiguration Response frame, to indicate all successfully established corresponding TWT agreements for the switch link operation. Other variations for the response can be provided, for example, as discussed above for FIGS. 2 and 3. It is noted that for scenarios in which corresponding TWT agreements are established on multiple corresponding links, a Per-STA profile subelement is provided per-link to indicate the TWT element(s) for TWT agreement(s) that were successfully established on each corresponding link.

FIG. 4D-2 illustrates a second format 431-2 for the TWT Transfer Info field 431 that can be used to indicate transfer for one or more corresponding TWT agreements based on one or more corresponding TWT IDs of the one or more corresponding TWT agreements.

Generally, a TWT ID is an identifier of a TWT element. For iTWT, a TWT ID is referred to as a ‘TWT Flow Identifier’ and is defined to be 3 bits. For bTWT or rTWT, a TWT ID is referred to as a ‘Broadcast TWT ID’ and is defined to be 5 bits. In at least one embodiment, TWT ID(s) can be signaled via the TWT Transfer Info Field 431 utilizing a format of <TWT Type, TWT ID(s)> for different type(s) of TWT ID(s) that are requested to be transferred. In at least one embodiment, TWT type can be set to indicate an iTWT type in which the corresponding TWT ID(s) will indicate TWT Flow Identifier(s) (for iTWT agreement(s)) and/or can be set to indicate a bTWT type in which the corresponding TWT ID(s) will indicate Broadcast TWT ID(s) (for bTWT or rTWT agreement(s)). It is to be understood that any combination of iTWT, bTWT, and/or rTWT ID(s) can be signaled using one or more <TWT Type, TWT ID(s)> indications.

When an AP MLD, such as AP MLD 112-1, receives the TWT Transfer Info field 431, formatted according to the second format 431-2 as shown in FIG. 4D-2, in a STA Info field (enhanced as shown in FIG. 4C) with one or more corresponding <TWT Type, TWT ID(s)> included therein, the AP MLD will attempt to establish corresponding TWT agreements that are established on the link being deleted on to the new link being added. For all the corresponding TWT agreements that were successfully established on the new link, the AP MLD will send one or more corresponding TWT element for each of the one or more corresponding TWT agreements in the STA Profile field of the Per-STA Profile subelement included for the added link in the Link Reconfiguration Response frame, to indicate all the successfully established TWT agreements for the switch link operation. Other variations for the response can be provided, for example, as discussed above for FIGS. 2 and 3. It is noted that for scenarios in which corresponding TWT agreements are established on multiple corresponding links, a Per-STA profile subelement can be provided per-link to indicate the TWT element(s) for TWT agreement(s) that were successfully established on each corresponding link.

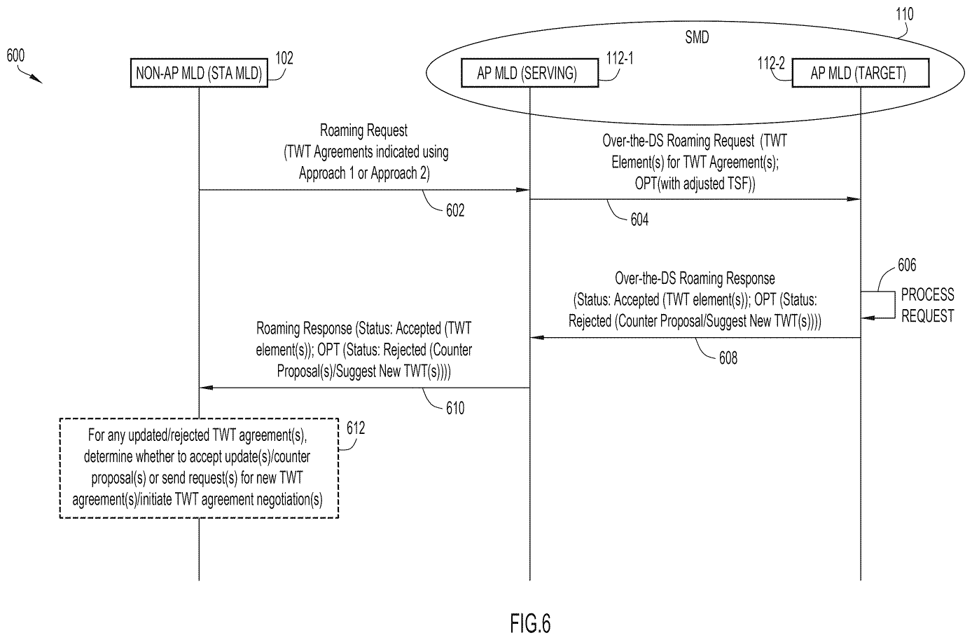

Moving to FIG. 5, FIG. 5 is a flowchart depicting a method 500 according to an example embodiment. In at least one embodiment, method 500 can be associated with facilitating the transfer of one or more TWT agreements from one link to another link within/for a given AP MLD as part of ML Link Reconfiguration signaling. In at least one embodiment, method 500 can be performed at least by an AP MLD, such as AP MLD 112-1.

As shown at 502, the method may include obtaining, from a non-AP MLD, a request to transfer one or more TWT agreements for the non-AP MLD from at least one first wireless link of an AP MLD to at least one second wireless link of the AP MLD. In at least one embodiment, the request may include a request to establish one or more new TWT agreements for at least one wireless link of the AP MLD. In various embodiments, the request can include a Link Reconfiguration Request frame or a management frame. In at least one embodiment, the request can correspond to at least one of an add link operation, a switch link operation, or a delete link operation.

In at least one embodiment, the request indicates the one or more TWT agreements that are requested to be transferred to the at least one second wireless link of the AP MLD using one of: one or two TWT elements for each TWT agreement of the one or more TWT agreements; a TWT agreement type and a TWT identifier for each TWT agreement of the one or more TWT agreements; or a TWT agreement type identifier for each type of the one or more TWT agreements. In at least one embodiment, one of the TWT agreement type and a TWT identifier for each TWT agreement of the one or more TWT agreements or the TWT agreement type identifier for each type of the one or more TWT agreements are indicated in a TWT transfer information field of a station information (STA Info) field of a per-station profile (Per-STA Profile) subelement of the request.

In at least one embodiment, the TWT transfer information field of the STA Info field of the Per-STA Profile subelement includes one or more of: a first field that is set to indicate that all individual TWT agreements for the non-AP MLD that are set up on the first wireless link are requested to be transferred to the second wireless link; a second field that is set to indicate that all broadcast TWT agreements for the non-AP MLD that are set up on the first wireless link are requested to be transferred to the second wireless link; or a third field that is set to indicate that all restricted TWT agreements for the non-AP MLD that are set up on the first wireless link are requested to be transferred to the second wireless link. In at least one embodiment, if the request is to delete a particular link (e.g., for a delete operation or switch operation), the request can also indicate one or more Link IDs (e.g., in the STA Info field) for the link(s) where the non-AP MLD is requesting to transfer/establish the indicated TWT agreements.

In at least one embodiment, the TWT transfer information field can include a Link ID field to explicitly indicate the link of the AP MLD where the TWT agreements indicated for transfer are currently established.

As shown at 504, the method may include determining, by the AP MLD, whether any of the one or more TWT agreements (existing and/or new) are accepted for the at least one second wireless link of the AP MLD.

As shown at 506, the method may include providing a response to the non-AP MLD indicating whether any of the one or more TWT agreements are accepted for the second wireless link of the AP MLD. In at least one embodiment, for one or more TWT agreements for which TWT setup is successful on the at least one second wireless link, the AP MLD can indicate such by including one or more corresponding TWT elements for the one or more corresponding TWT agreements in the STA Profile field of the Per-STA Profile element of a Reconfiguration ML element or a Basic ML element. In at least one embodiment, if the corresponding TWT agreements are established on multiple corresponding links, a Per-STA profile subelement can be provided per-link to indicate the TWT element(s) for TWT agreement(s) that were successfully established on each corresponding link.

Embodiments herein may also enable the transfer of one or more TWT agreements across links of different AP MLDs in an SMD, such as transferring one or more TWT agreements between at least one first link between non-AP MLD 102 and AP MLD 112-1 and at least one second link between non-AP MLD 102 and AP MLD 112-2 for a roaming scenario in which non-AP MLD 102 seeks to roam from AP MLD 112-1 to AP MLD 112-2.

In various embodiments, the techniques, signaling, etc. as described above (e.g., with reference to FIGS. 2, 3, 4A, 4B, 4C, 4D-1, and 4D-2) for transferring TWT agreements transfer between links of an AP MLD can also be used to transfer TWT agreements from one link to another link when a STA/non-AP MLD moves its links across two different AP MLDs within an SMD. This may occur as part of roaming when a non-AP MLD roams from one AP MLD to another AP MLD within the SMD. As noted above, an SMD, such as SMD 110, is a mobility domain for seamless roaming that consists of a set of AP MLDs within the same Extended Service Set (ESS), such as AP MLDs 112-1, 112-2, through AP MLD 112-X that support seamless roaming for non-AP MLDs (e.g., non-AP MLD 102) between themselves and that are identified by an SMD MAC address.

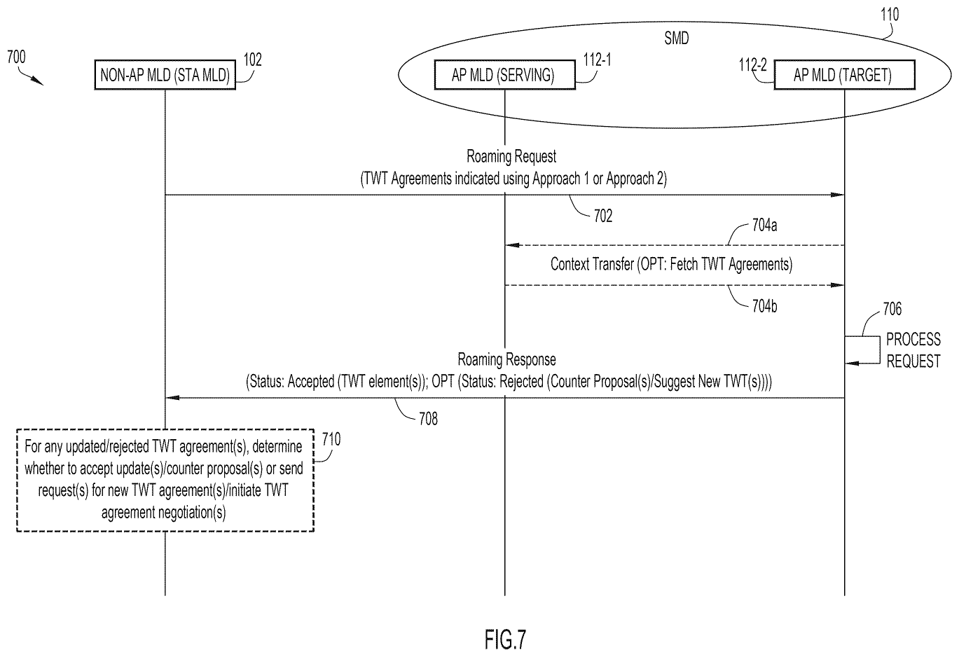

With reference to FIG. 6, FIG. 6 illustrates a call flow or sequence diagram 600 for facilitating TWT agreement transfer across AP MLD 112-1 (referred to in FIG. 6 as the Serving AP MLD) and AP MLD 112-2 (referred to in FIG. 6 as the Target AP MLD) during an over-the-Distribution System (DS) or OTDS roaming scenario involving non-AP MLD 102. In particular, sequence diagram 600 allows for TWT agreements to be transferred to added link(s) of a target AP MLD (e.g., AP MLD 112-2 in this example) during OTDS roaming.

As illustrated at 602, the non-AP MLD 102 can send a roaming request frame (e.g., an over-the-air (OTA) roaming request frame) to the Serving AP MLD, AP MLD 112-1 in this example, that indicates the TWT agreement(s) that are requested to be transferred to added link(s) of the Target AP, AP MLD 112-2. In at least one embodiment, a roaming request in an SMD can be signaled using a Link Reconfiguration Request frame, which can include the various enhancements as discussed above regarding transfer of TWT agreement(s) within an AP MLD. In at least one embodiment, a roaming request in an SMD can be signaled using a Fast Transition (FT) request frame (for Fast BSS (Basic Service Set) Transition) or any management frame.

In various embodiments, the non-AP MLD 102 can indicate the TWT agreement(s) requested to be to transferred to the Target AP MLD (AP MLD 112-2) using techniques as provided via Approach 1 or Approach 2 as discussed herein by including any of one or more TWT elements (in the STA Profile field), one or more TWT IDs (via TWT Type/ID indication(s) provided in the TWT Transfer Info field), or one or more TWT type indications (in the TWT Transfer Info field) in the roaming request frame (or Link Reconfiguration Request frame) to request transfer of one or more TWT agreements from the Serving AP MLD, AP MLD 112-1, to the Target AP MLD, AP MLD 112-2, for roaming within the SMD 110. In the roaming request frame, the non-AP MLD 102 also indicates the Target AP MLD (AP MLD 112-2) MAC address. In various embodiments, the Target AP MLD MAC address can be carried in the Reconfiguration ML element in the Common Info field or can be carried in a new element added to the roaming request.

Further in the roaming request frame, the non-AP MLD 102 also indicates corresponding link ID(s) of the Serving AP MLD (AP MLD 112-1) where the TWT agreement(s) requested to be transferred are currently established. For example, the TWT Transfer Info field in FIG. 4C can be extended to include the Link ID field 432 indicating the link of the serving AP MLD where the indicated TWT agreement(s) are established. In another embodiment, if the non-AP MLD 102 requests to transfer TWT agreements from more than one link of the current (Serving) AP MLD to a link of a Target AP MLD, then the non-AP MLD 102 can include multiple instances of TWT Transfer Info field, each indicating TWT agreement(s) requested to be transferred from one of the links of the serving AP MLD.

In at least one embodiment, the non-AP MLD 102 can also request to set up one or more new TWT agreements as part of a roaming request by including one or more corresponding TWT element for each of one or more corresponding new TWT agreements in the Per-STA Profile subelement, as discussed above. In at least one embodiment, the Target Wake Time field in at least one TWT element may be adjusted by the Serving AP MLD (AP MLD 112-1) to align with the TSF of the Target AP MLD (AP MLD 112-2). The response to the non-AP MLD can provide updated TWT elements for accepted TWT agreements with the Target Wake Time field adjusted to align with the TSF of the target AP MLD.

In some embodiments, the non-AP MLD 102 can request to transfer TWT agreements from multiple links of the Serving AP MLD (AP MLD 112-1) to one link of the target AP MLD (AP MLD 112-2).

For an added link with a Target AP MLD, the non-AP MLD 102 may indicate the link of the Serving AP MLD (AP MLD 112-1) from which the non-AP MLD 102 wants TWT agreements to be moved to the added link (e.g., using the Link ID field 432, as discussed above).

Upon obtaining the roaming request by the Serving AP MLD (AP MLD 112-1), the AP MLD 112-1, in at least one embodiment, can send an over-the-DS roaming request to the Target AP MLD (AP MLD 112-2), as shown at 604, that indicates the one or more corresponding TWT elements for the one or more corresponding agreements that the non-AP MLD 102 requests to be transferred to new link(s) of the AP MLD 112-2.

In some embodiments, for example, if TWT ID(s) (e.g., Approach 1) or TWT type(s) (e.g., Approach 2) are included in the roaming request received from the non-AP MLD 102, the Serving AP MLD, AP MLD 112-1, may perform a look-up on the corresponding TWT agreements maintained for the non-AP MLD 102 in order to identify the corresponding TWT elements for the corresponding TWT agreements to send to the Target AP MLD, AP MLD 112-2.

As shown at 604, the Serving AP MLD, AP MLD 112-1, can send an over-the-DS roaming request to the Target AP MLD, AP MLD 112-2, that includes corresponding TWT element(s) for the corresponding TWT agreement(s) that are requested to be transferred to the link of the target AP MLD based on the roaming request that the Serving AP MLD received from the non-AP MLD 102.

In some embodiments, the Serving AP MLD, AP MLD 112-1, knowing the Time Synchronization Function (TSF) offset (sometimes referred to as ‘time base’) of the Target AP MLD, AP MLD 112-2 (e.g., the system clock offset of the Target AP MLD in relation to the Serving AP MLD), can update the Target Wake Time (service start time) of the one or more corresponding TWT elements for the one or more corresponding TWT agreements requested to be transferred to the Target AP MLD. In some embodiments, the Target AP MLD, AP MLD 112-2, can update the Target Wake Time of the corresponding TWT agreement(s) on its own.

As shown at 606, the Target AP MLD, AP MLD 112-2, can process the roaming request and make a decision as to whether the one or more TWT agreements can be accepted for the added link(s) and can signal an over-the-DS roaming response (or an over-the-DS Link Reconfiguration Response frame, an over-the-DS FT response frame, or over-the-DS management frame) to the Serving AP MLD, AP MLD 112-1, as generally shown at 608, that includes various information indicating the decision regarding the request to transfer the TWT agreement(s) to the added link(s), as discussed in further detail herein, below.

If the add/delete/switch link operation is successful for the non-AP MLD 102, then the Target AP MLD, AP MLD 112-2, with which the new link(s) is/are added, establishes the indicated TWT agreements on the new link(s) for the non-AP MLD 102 and signals to the Serving AP MLD, AP MLD 112-1, at 608, via the over-the-DS roaming response frame (or Link Reconfiguration Response frame), the one or more corresponding TWT elements for the one or more corresponding TWT agreements that are accepted for the newly added link(s).

As shown at 661, the Serving AP MLD, AP MLD 112-1, can send a roaming response frame, for example, an OTA roaming response frame (or Link Reconfiguration Response frame, FT response frame, or management frame) to the non-AP MLD 102 that indicates the one or more corresponding TWT elements for the one or more corresponding accepted TWT agreements.

The Target AP MLD, AP MLD 112-2, may not accept all the TWT agreements requested to be transferred to an added link (e.g., the requested TWT agreements may conflict with existing TWT agreements of the Target AP MLD or may not be supported by the AP MLD) and the Target AP MLD may accept only a subset of requested TWT agreements on the newly added link.

In some embodiments, the Target AP MLD, AP MLD 112-2, may update accepted TWT agreement(s) with a new Target Wake Time (service start time) based on the TSF of the Target AP MLD, which the non-AP MLD 102 is to either accept or trigger new negotiations with the Target AP MLD. Thus, an updated TWT agreement may be indicated as accepted by the Target AP MLD but may include an updated TWT element that the non-AP MLD 102 is expected to either accept or to trigger a new TWT negotiation (if the non-AP MLD 102 does not accept the updated TWT agreement/TWT element). Although service start time is discussed as an update for this example, it is to be understood that a Target AP MLD may accept a corresponding TWT agreement to transfer to a new link but may update any TWT fields(s) of a corresponding TWT element for a corresponding TWT agreement (and indicate such to a non-AP MLD) in accordance with embodiments herein.

In some embodiments, the Target AP MLD, AP MLD 112-2, may provide one or more indications to/for the non-AP MLD 102 in the over-the-DS roaming response frame (or Link Reconfiguration Response frame, FT response frame, or management frame) sent at 608 that may indicate one or more rejected TWT agreements (that cannot be transferred to the new link(s) or that cannot be newly created for the new link(s)) and may provide one or more counter proposal TWT elements for the one or more rejected TWT agreements and/or may provide an indication for one or more new TWT agreements (e.g., indicate corresponding new TWT element(s) for corresponding new TWT agreement(s)) that the AP MLD 112-2 can immediately accept for the newly link(s) (e.g., via use of the STA Profile of the Per-STA Profile subelement for the new link that is being set up (in the case of add link or switch link case) or can be indicated in the Per-STA Profile for a deleted link (for delete link case) along with indicating a Link ID where the counter proposed TWT agreements can be accepted and corresponding indication(s) provided via the ‘TWT Setup Command’ field).

For embodiments in which a Target AP MLD is not able to successfully transfer one or more TWT agreements to a newly added link, the Target AP MLD can include a rejection status indicator in the over-the-DS roaming response frame (or Link Reconfiguration Response frame, FT response frame, or management frame) and may provide one or more counter proposal TWT elements for one or more rejected TWT agreements and/or may provide an indication for one or more new TWT agreements (e.g., indicate a corresponding new TWT element for a corresponding new TWT agreement) that the Target AP MLD can immediately accept for the newly added link(s).

For embodiments in which one or more TWT agreements have been accepted but updated by the Target AP MLD or in which the Target AP MLD has provided counter proposal(s)/indicated TWT agreement(s) that can be accepted immediately, for example, as shown at 612, the non-AP MLD 102 can evaluate/process each TWT agreement. For example, the non-AP MLD 102 can determine one or more of: whether to accept an updated TWT element for a Target AP MLD accepted but updated TWT agreement (e.g., updated with a new service start time based on the TSF of the Target AP MLD or other updated field); whether to accept a TWT element for a corresponding counter proposed TWT agreement; whether to send a request to the Target AP MLD that requests a new TWT agreement (including a TWT element for the new TWT agreement suggested by the TWT AP MLD); and/or whether to initiate a new TWT negotiation with the Target AP MLD, AP MLD 112-2. Based on the determination at 610, the non-AP MLD 102 may trigger one or more requests/signaling towards the Target AP MLD (not shown).

For embodiments in which the non-AP MLD 102 requested one or more new TWT agreements to be set up on the Target AP MLD 112-2, the response to the non-AP MLD 102 can include updated TWT elements for accepted TWT agreements with the Target Wake Time field adjusted to align with the TSF of the Target AP MLD 112-2.

Note that in all the embodiments presented herein, the functionality of Link Reconfiguration Request/Response frames can be performed by FT request/response frames other roaming request/response management frames.

With reference to FIG. 7, FIG. 7 illustrates a call flow or sequence diagram 700 for facilitating TWT agreement transfer across AP MLD 112-1 (referred to in FIG. 7 as the Serving AP MLD) and AP MLD 112-2 (referred to in FIG. 7 as the Target AP MLD) during an over-the-air (OTA) roaming involving non-AP MLD 102. In particular, FIG. 7 illustrates example details for transferring TWT agreements to added link(s) of the Target AP MLD during OTA roaming.

As illustrated at 702, the non-AP MLD 102 can send an OTA roaming request frame (or OTA Link Reconfiguration Request frame, OTA FT request frame, or OTA management frame) to the Target AP MLD, AP MLD 112-2 in this example, that indicates the TWT agreement(s) that are requested to be transferred to added link(s) of the Target AP, AP MLD 112-2.

In various embodiments, the non-AP MLD 102 can indicate the TWT agreement(s) requested to be to transferred to the Target AP MLD (AP MLD 112-2) in the OTA roaming request frame (or Link Reconfiguration Request frame, FT request frame, or management frame) using techniques as provided via Approach 1 or Approach 2 as discussed herein by including any of one or more TWT elements (in the STA Profile field), one or more TWT IDs (in the TWT Transfer Info field), or one or more TWT type indications (in the TWT Transfer Info field) to request transfer of one or more TWT agreements from the Serving AP MLD, AP MLD 112-1, to the Target AP MLD, AP MLD 112-2, for roaming within the SMD 110. In at least one embodiment, the non-AP MLD 102 can also request to set up one or more new TWT agreements as part of a roaming request by including one or more corresponding TWT element for each one or more corresponding new TWT agreements in the Per-STA Profile subelement, as discussed above.

Further in the OTA roaming request frame, the non-AP MLD 102 also indicates corresponding link ID(s) of the Serving AP MLD (AP MLD 112-1) where the TWT agreement(s) requested to be transferred are currently established. For example, the TWT Transfer Info field in FIG. 4C can be extended to include the Link ID field 432 indicating the link of the serving AP MLD where the indicated TWT agreement(s) are established. In another embodiment, if the non-AP MLD 102 requests to transfer TWT agreements from more than one link of the current (Serving) AP MLD to a link of a Target AP MLD, then the non-AP MLD 102 can include multiple instances of TWT Transfer Info field, each indicating TWT agreement(s) requested to be transferred from one of the links of the serving AP MLD.

In some embodiments, such as if the OTA roaming request sent to the Target AP MLD, AP MLD 112-2, includes TWT ID(s) (e.g., Approach 1) or TWT agreement type(s) (e.g., Approach 2), the Target AP MLD, AP MLD 112-2, can be triggered to fetch corresponding TWT agreement(s) from the Serving AP MLD, AP MLD 112-1, for the corresponding TWT ID(s)/agreement type(s) identified in the OTA roaming request, as generally shown at 704a and 704b, which can be performed as part of a roaming context transfer with the Serving AP MLD. A roaming context transfer is typically used to fetch the context of the non-AP MLD from the Serving AP MLD (e.g., Block Ack agreements, QoS related agreements etc.) that were established between the non-AP MLD and the serving AP MLD.

In at least one embodiment, the non-AP MLD 102 can also request to set up one or more new TWT agreements as part of the OTA roaming request by including one or more corresponding TWT element for each of one or more corresponding new TWT agreements in the Per-STA Profile subelement, as discussed above.

In some embodiments, the non-AP MLD 102 can request to transfer TWT agreements from multiple links of the Serving AP MLD (AP MLD 112-1) to one link of the target AP MLD (AP MLD 112-2).

As shown at 706, the Target AP MLD, AP MLD 112-2, can process the roaming request and make a decision as to whether the one or more TWT agreements can be accepted for the added link(s) and can signal an OTA roaming response frame (or an OTA Link Reconfiguration Response frame, FT response frame, or management frame) to the non-AP MLD 102, as generally shown at 708, that includes various information indicating the decision regarding the request to transfer the TWT agreement(s) to the added link(s), as discussed in further detail herein, below.

If the operation is successful for the non-AP MLD 102, then the Target AP MLD, AP MLD 112-2, with which the new link(s) is/are added, establishes the indicated TWT agreement(s) on the new link(s) for the non-AP MLD 102 and signals to non-AP MLD 102 at 708, via the OTA roaming response frame (or Link Reconfiguration Response frame, FT response from, or management frame), the one or more corresponding TWT elements for the one or more corresponding TWT agreements that are accepted for the newly added link(s).

The Target AP MLD, AP MLD 112-2, may not accept all the TWT agreements requested to be transferred to an added link and the Target AP MLD may accept only a subset of requested TWT agreements on the newly added link.

In some embodiments, the Target AP MLD, AP MLD 112-2, may update accepted TWT agreement(s) with a new Target Wake Time (service start time) based on the TSF of the Target AP MLD, which the non-AP MLD 102 is to either accept or trigger new negotiations with the Target AP MLD. Thus, an updated TWT agreement may be indicated as accepted by the Target AP MLD but may include an updated TWT element that the non-AP MLD 102 is expected to either accept or to trigger a new TWT negotiation (if the non-AP MLD 102 does not accept the updated TWT agreement/TWT element). Although service start time is discussed as an update for this example, it is to be understood that a Target AP MLD may accept a corresponding TWT agreement to transfer to a new link but may update any TWT field(s) of the corresponding TWT element for the corresponding TWT agreement (and indicate such to a non-AP MLD) in accordance with embodiments herein.

In some embodiments, the Target AP MLD, AP MLD 112-2, may provide one or more indications to the non-AP MLD 102 in the OTA roaming response frame (or Link Reconfiguration Response frame) sent at 708 that may indicate one or more rejected TWT agreements (that cannot be transferred to the new link(s) or that cannot be newly created for the new link(s)) and may provide one or more counter proposal TWT elements for the one or more rejected TWT agreements and/or may provide an indication for one or more new TWT agreements (e.g., indicate corresponding new TWT element(s) for corresponding new TWT agreement(s)) that the AP MLD 112-2 can immediately accept for the newly link(s).

For embodiments in which a Target AP MLD is not able to successfully transfer one or more TWT agreements to a newly added link, the Target AP MLD can include a rejection status indicator in the OTA roaming response frame (or Link Reconfiguration Response frame) and may provide counter proposal TWT element(s) for any rejected TWT agreement(s) and/or may provide an indication for one or more new TWT agreements (e.g., indicate a corresponding new TWT elements for a corresponding new TWT agreement) that the Target AP MLD can immediately accept for the newly added link(s).

For embodiments in which one or more TWT agreements have been accepted but updated by the Target AP MLD or in which the Target AP MLD has provided counter proposal(s)/indicated TWT agreement(s) that can be accepted immediately, for example, as shown at 710, the non-AP MLD can evaluate/process each TWT agreement. For example, the non-AP MLD 102 can determine one or more of: whether to accept an updated TWT element for an accepted but updated TWT agreement (e.g., updated with a new service start time based on the TSF of the Target AP MLD or other updated field); whether to accept a corresponding TWT element for a corresponding counter proposed TWT agreement; whether to send a request to the Target AP MLD that requests a new TWT agreement (including a new TWT element for the new TWT agreement suggested by the TWT AP MLD); and/or whether to initiate a new TWT negotiation with the Target AP MLD, AP MLD 112-2. Based on the determination at 614 or 710, the non-AP MLD 102 may trigger one or more requests/signaling towards the Target AP MLD for TWT agreements setup (not shown).

Thus, in various embodiments as discussed with reference to FIGS. 6 and 7, a Target AP MLD can obtain one or more TWT agreements to transfer to new link(s): a) from a non-AP MLD, as part of the Link Reconfiguration Request frame (or a roaming request frame) indicating a switch link or add link operation; b) can retrieve the TWT agreement(s) from the Serving AP MLD where the current link(s) is/are set up using over-the-DS exchanges during roaming; or c) can be provided the one or more TWT agreements to set up from the Serving AP MLD as part of roaming exchange over-the-DS.

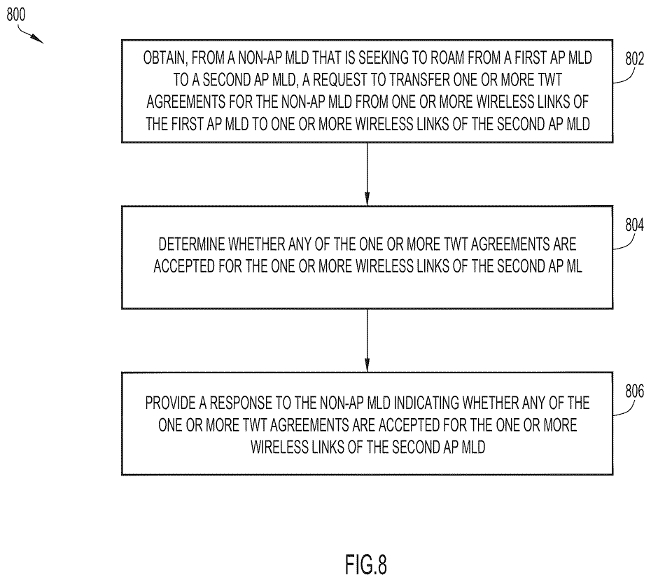

Referring to FIG. 8, FIG. 8 is a flowchart depicting a method 800 according to an example embodiment. In at least one embodiment, method 800 can be associated with facilitating the transfer of one or more TWT agreements from one link to another link across AP MLDs that are part of an SMD for a roaming scenario involving a non-AP MLD. In at least one embodiment, method 800 can be performed by at least one or more AP MLDs, such as by AP MLD 112-1 and/or AP MLD 112-2.

As shown at 802, the method may include obtaining, from a non-AP MLD that is seeking to roam from a first AP MLD to a second AP MLD, a request to transfer one or more TWT agreements for the non-AP MLD from one or more wireless links of the first AP MLD to one or more wireless links of the second AP MLD. In various embodiments, the request corresponds to at least one of an add link operation, a switch link operation, or a delete link operation. The request can further indicate wireless link identifier (ID) information indicating at least one wireless link of the first AP MLD at which the one or more TWT agreements that are requested to be transferred are currently set up.

In at least one embodiment, the request indicates the one or more TWT agreements that are requested to be transferred to the one or more wireless links of the second AP MLD using one of: one or two TWT elements for each TWT agreement of the one or more TWT agreements; a TWT agreement type and a TWT identifier for each TWT agreement of the one or more TWT agreements; or a TWT agreement type identifier for each type of the one or more TWT agreements. In at least one embodiment, the wireless link ID information, the TWT agreement type and the TWT identifier for each TWT agreement of the one or more TWT agreements or the wireless link ID information and the TWT agreement type identifier for each type of the one or more TWT agreements are indicated in a TWT transfer information field of a station information (STA Info) field of a per-station profile (Per-STA Profile) subelement of the request.

In at least one embodiment, the TWT transfer information field of the STA Info field of the Per-STA Profile subelement includes one or more of: a first field that is set to indicate that all individual TWT agreements for the non-AP MLD that are set up on a particular wireless link of the first AP MLD are requested to be transferred; a second field that is set to indicate that all broadcast TWT agreements for the non-AP MLD that are set up on a particular wireless link of the first AP MLD are requested to be transferred; or a third field that is set to indicate that all restricted TWT agreements for the non-AP MLD that are set up on a particular wireless link of the first AP MLD are requested to be transferred. In at least one embodiment, the request can TWT agreements from multiple wireless links of the first AP MLD to be transferred to a particular wireless link of the second AP MLD.

As shown at 804, the method may include determining whether any of the one or more TWT agreements are accepted for the one or more wireless links of the second AP MLD.

As shown at 806, the method may include providing a response to the non-AP MLD indicating whether any of the one or more TWT agreements are accepted for the one or more wireless links of the second AP MLD. In at least one embodiment, for a particular TWT agreement that is accepted for the wireless link of the second AP MLD, the response includes a TWT element for the particular TWT agreement that is accepted. In at least one embodiment, the TWT element is provided in a per-station profile (Per-STA Profile) subelement of the response.

In at least one embodiment, for the particular TWT agreement that is accepted for the wireless link of the second AP MLD, at least one field of the TWT element is updated to adjust for a time synchronization function (TSF) of the one or more wireless links of the second AP MLD. In at least one embodiment, the response further indicates one or more of: at least one counter proposal TWT agreement for at least one TWT agreement that is not accepted for the one or more wireless links; or at least one new TWT agreement that is capable of being accepted for the one or more wireless links by the second AP MLD.

In at least one embodiment, the request can be a first request that is obtained by the first AP MLD from the non-AP MLD in which the method may further include transmitting, by the first AP MLD, a second request to the second AP MLD via a distribution system (DS) communication that includes one or more TWT elements for the one or more TWT agreements to be transferred to the one or more wireless links of the second AP MLD based on the first request, wherein the second AP MLD determines whether any of the one or more TWT agreements are accepted for the one or more wireless links of the second AP MLD; and obtaining the response, by the first AP MLD from the second AP MLD via another DS communication, wherein providing the response to the non-AP MLD includes the first AP MLD transmitting the response to the non-AP MLD.

In at least one embodiment, the request is obtained by the second AP MLD from the non-AP MLD and the response is provided by second AP MLD. In such an embodiment, upon the request indicating wireless link identifying information for the one or more wireless links of the first AP MLD and a TWT agreement type and TWT identifier for each TWT agreement of the one or more TWT agreements or the request indicating wireless link identifying information for the one or more wireless links of the first AP MLD and a TWT agreement type identifier for each type of the one or more TWT agreements, the method may further include fetching the one or more TWT agreements from the first AP MLD by the second AP MLD as part of roaming context transfer communications between the first AP MLD and the second AP MLD.

In at least one embodiment, the request further includes one or more TWT elements for one or more new TWT agreements requested to be set up for at least one wireless link of the second AP MLD. In such an embodiment, a corresponding TWT element for each of the one or more new TWT agreements is included in a per-station profile (Per-STA Profile) subelement for the at least one wireless link of the second AP MLD where the new TWT agreement is requested to be set up.

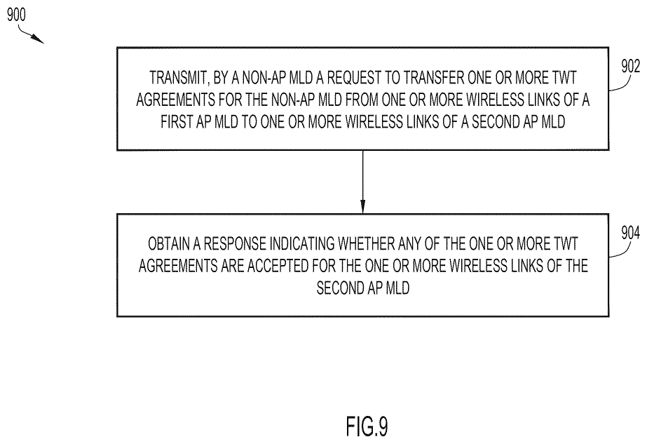

Referring to FIG. 9, FIG. 9 is a flowchart depicting a method 900 according to an example embodiment. In at least one embodiment, method 900 can be associated with facilitating the transfer of one or more TWT agreements from one link to another link within an AP MLD for a non-roaming scenario or across AP MLDs that are part of an SMD for a roaming scenario involving a non-AP MLD. In at least one embodiment, method 900 can be performed at least by a non-AP MLD, such as non-AP MLD 102.

As shown at 902, the method may include transmitting, by a non-AP MLD a request to transfer one or more TWT agreements for the non-AP MLD from one or more wireless links of a first AP MLD to one or more wireless links of a second AP MLD. The request can be a roaming request frame, a link reconfiguration request frame, a FT request frame, or a management frame in which the request can correspond to at least one of an add link operation, a switch link operation, or a delete link operation.

In at least one embodiment, the request indicates the one or more TWT agreements that are requested to be transferred to the one or more wireless links of the second AP MLD using one of: one or two TWT elements for each TWT agreement of the one or more TWT agreements; a TWT agreement type and a TWT identifier for each TWT agreement of the one or more TWT agreements; or a TWT agreement type identifier for each type of the one or more TWT agreements.

In at least one embodiment, the request further includes wireless link identifier (ID) information indicating at least one wireless link of the first AP MLD at which the one or more TWT that are requested to be transferred are set up. In at least one embodiment, the wireless link ID information, the TWT agreement type and the TWT identifier for each TWT agreement of the one or more TWT agreements or the wireless link ID information and the TWT agreement type identifier for each type of the one or more TWT agreements are indicated in a TWT transfer information field of a station information (STA Info) field of a per-station profile (Per-STA Profile) subelement of the request.

In at least one embodiment, the request further indicates a plurality of TWT agreements from multiple wireless links of the first AP MLD to be transferred to a particular wireless link of the second AP MLD.

In at least one embodiment, the request further includes one or more TWT elements for one or more new TWT agreements requested to be set up for at least one wireless link of the second AP MLD. In at least one embodiment, a corresponding TWT element for each of the one or more new TWT agreements is included in a per-station profile (Per-STA Profile) subelement for the at least one wireless link of the second AP MLD where the one or more new TWT agreements are requested to be set up.

In at least one embodiment, the request is transmitted to the first AP MLD. In at least one embodiment, the request is transmitted to the second AP MLD.

As shown at 904, the method may include obtaining a response indicating whether any of the one or more TWT agreements are accepted for the one or more wireless links of the second AP MLD. The response can be a roaming response frame, a link reconfiguration response frame, an FT response frame, or a management frame.

In at least one embodiment, for a particular TWT agreement that is accepted for the wireless link of the second AP MLD, the response includes a TWT element for the particular TWT agreement that is accepted. In at least one embodiment, the TWT element is provided in a per-station profile (Per-STA Profile) subelement of the response. In at least one embodiment, for the particular TWT agreement that is accepted for the wireless link of the second AP MLD, at least one field of the TWT element is updated to adjust for a time synchronization function (TSF) of the one or more wireless links of the second AP MLD.

In at least one embodiment, the response further indicates one or more of: at least one counter proposal TWT agreement for at least one TWT agreement that is not accepted for the one or more wireless links; or at least one new TWT agreement that is capable of being accepted for the one or more wireless links by the second AP MLD.

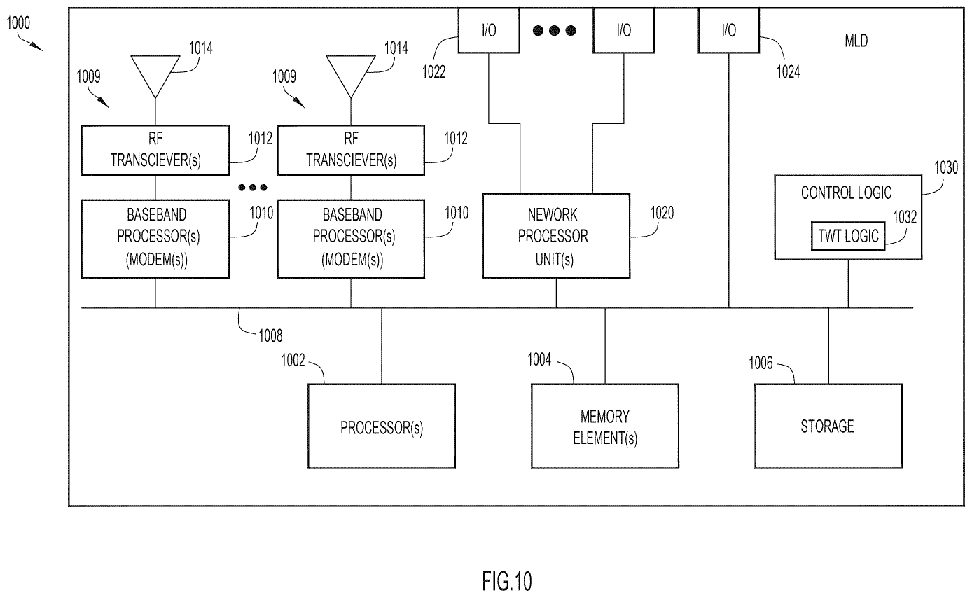

Referring to FIG. 10, FIG. 10 illustrates a hardware block diagram of a multi-link device (MLD) 1000 that may perform functions associated with operations discussed herein in connection with the techniques described for embodiments herein. In various embodiments, an MLD, such as MLD 1000, may be configured as any entity/entities in order to perform operations of the various techniques discussed for embodiments herein, such as any elements, functions, etc. discussed for embodiments herein (e.g., non-AP MLD 102, AP MLD 112-1, AP MLD 112-2, etc.).

In at least one embodiment, the MLD 1000 may be any apparatus that may include one or more processor(s) 1002, one or more memory element(s) 1004, storage 1006, a bus 1008, a plurality of STA or RF modules 1009 each consisting of a baseband processor (modem) 1010, one or more RF transceivers 1012 and an antenna 1014 (or group of antennas). The MLD 1000 may further include one or more network processor unit(s) 1020 interconnected with one or more network input/output (I/O) interface(s) 1022, one or more I/O interface(s) 1024, and control logic 1030, which may be configured with TWT logic 1032. In various embodiments, instructions associated with logic for MLD 1000 can overlap in any manner and are not limited to the specific allocation of instructions and/or operations described herein.

In at least one embodiment, processor(s) 1002 is/are at least one hardware processor configured to execute various tasks, operations and/or functions for MLD 1000 as described herein according to software and/or instructions configured for MLD 1000. Processor(s) 1002 (e.g., a hardware processor) can execute any type of instructions associated with data to achieve the operations detailed herein. In one example, processor(s) 1002 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 1004 and/or storage 1006 is/are configured to store data, information, software, and/or instructions associated with MLD 1000, and/or logic configured for memory element(s) 1004 and/or storage 1006. For example, any logic described herein (e.g., control logic 1030, TWT logic 1032, etc.) can, in various embodiments, be stored for MLD 1000 using any combination of memory element(s) 1004 and/or storage 1006. Note that in some embodiments, storage 1006 can be consolidated with memory element(s) 1004 (or vice versa) or can overlap/exist in any other suitable manner.

In at least one embodiment, bus 1008 can be configured as an interface that enables one or more elements of MLD 1000 to communicate in order to exchange information and/or data. Bus 1008 can be implemented with any architecture designed for passing control, data and/or information between processors, memory elements/storage, peripheral devices, and/or any other hardware and/or software components that may be configured for MLD 1000. In at least one embodiment, bus 1008 may be implemented as a fast kernel-hosted interconnect, potentially using shared memory between processes (e.g., logic), which can enable efficient communication paths between the processes.

In various embodiments, network processor unit(s) 1020 may enable communication between MLD 1000 and other systems, entities, etc., via network I/O interface(s) 1022 (wired and/or wireless) to facilitate operations discussed for various embodiments described herein. In various embodiments, network processor unit(s) 1020 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between MLD 1000 and other systems, entities, etc. to facilitate operations for various embodiments described herein. In various embodiments, network I/O interface(s) 1022 can be configured as one or more Ethernet port(s), Fibre Channel ports, any other I/O port(s), and/or antenna(s)/antenna array(s) now known or hereafter developed. Thus, the network processor unit(s) 1020 and/or network I/O interface(s) 1022 may include suitable interfaces for receiving, transmitting, and/or otherwise communicating data and/or information (wired and/or wirelessly) in a network environment.

I/O interface(s) 1024 allow for input and output of data and/or information with other entities that may be connected to MLD 1000. For example, I/O interface(s) 1024 may provide a connection to external devices such as a keyboard, keypad, a touch screen, and/or any other suitable input and/or output device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

The RF transceiver(s) 1012 may perform RF transmission and RF reception of wireless signals via antenna(s) 1014, and the baseband processor or modem 1010 performs baseband modulation and demodulation, etc. associated with such signals to enable wireless communications for MLD 1000.

In various embodiments, control logic 1030 can be configured with TWT logic 1032 (which may include TWT logic for a STA/non-AP MLD or TWT logic for an AP MLD, as discussed herein) can include instructions that, when executed, cause processor(s) 1002 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 1030, TWT logic 1032, etc.) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, any entity or apparatus as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 1004 and/or storage 1006 can store data, software, code, instructions (e.g., processor instructions), logic, parameters, combinations thereof, and/or the like used for operations described herein. This includes memory element(s) 1004 and/or storage 1006 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

In some aspects, the techniques described herein relate to a computer-implemented method including: obtaining, from a non-access point multi-link device (non-AP MLD) that is seeking to roam from a first access point multi-link device (AP MLD) to a second AP MLD, a request to transfer one or more Target Wake Time (TWT) agreements for the non-AP MLD from one or more wireless links of the first AP MLD to one or more wireless links of the second AP MLD; determining whether any of the one or more TWT agreements are accepted for the one or more wireless links of the second AP MLD; and providing a response to the non-AP MLD indicating whether any of the one or more TWT agreements are accepted for the one or more wireless links of the second AP MLD.

In some aspects, the techniques described herein relate to a method, wherein the request is a roaming request frame, a link reconfiguration request frame, a Fast Transition (FT) request frame, or a management frame.

In some aspects, the techniques described herein relate to a method, wherein the request corresponds to at least one of an add link operation, a switch link operation, or a delete link operation.

In some aspects, the techniques described herein relate to a method, wherein the request indicates the one or more TWT agreements that are requested to be transferred to the one or more wireless links of the second AP MLD using one of: one or two TWT elements for each TWT agreement of the one or more TWT agreements; a TWT agreement type and a TWT identifier for each TWT agreement of the one or more TWT agreements; or a TWT agreement type identifier for each type of the one or more TWT agreements.

In some aspects, the techniques described herein relate to a method, wherein the request further indicates wireless link identifier (ID) information indicating at least one wireless link of the first AP MLD at which the one or more TWT agreements that are requested to be transferred are set up.

In some aspects, the techniques described herein relate to a method, wherein the wireless link ID information, the TWT agreement type and the TWT identifier for each TWT agreement of the one or more TWT agreements or the wireless link ID information and the TWT agreement type identifier for each type of the one or more TWT agreements are indicated in a TWT transfer information field of a station information (STA Info) field of a per-station profile (Per-STA Profile) subelement of the request.

In some aspects, the techniques described herein relate to a method, wherein the TWT transfer information field of the STA Info field of the Per-STA Profile subelement includes one or more of: a first field that is set to indicate that all individual TWT agreements for the non-AP MLD that are set up on a particular wireless link of the first AP MLD are requested to be transferred; a second field that is set to indicate that all broadcast TWT agreements for the non-AP MLD that are set up on a particular wireless link of the first AP MLD are requested to be transferred; or a third field that is set to indicate that all restricted TWT agreements for the non-AP MLD that are set up on a particular wireless link of the first AP MLD are requested to be transferred.

In some aspects, the techniques described herein relate to a method, wherein the request further indicates a plurality of TWT agreements from multiple wireless links of the first AP MLD to be transferred to a particular wireless link of the second AP MLD.

In some aspects, the techniques described herein relate to a method, wherein the response is a roaming response frame, a link reconfiguration response frame, a Fast Transition (FT) response frame, or a management frame.

In some aspects, the techniques described herein relate to a method wherein, for a particular TWT agreement that is accepted for the wireless link of the second AP MLD, the response includes a TWT element for the particular TWT agreement that is accepted.

In some aspects, the techniques described herein relate to a method, wherein the TWT element is provided in a per-station profile (Per-STA Profile) subelement of the response.

In some aspects, the techniques described herein relate to a method, wherein, for the particular TWT agreement that is accepted for the wireless link of the second AP MLD, at least a target wake time field of the TWT element is updated to adjust for a time synchronization function (TSF) offset of the particular wireless link of the second AP MLD for which the particular TWT agreement is accepted.

In some aspects, the techniques described herein relate to a method, wherein the response further indicates one or more of: at least one counter proposal TWT agreement for at least one TWT agreement that is not accepted for the one or more wireless links; or at least one new TWT agreement that is capable of being accepted for the one or more wireless links by the second AP MLD.

In some aspects, the techniques described herein relate to a method, wherein the request is a first request that is obtained by the first AP MLD from the non-AP MLD and the response is a first response that is provided to the non-AP MLD, the method further including: transmitting, by the first AP MLD, a second request to the second AP MLD via a distribution system (DS) communication that includes one or more TWT elements for the one or more TWT agreements to be transferred to the one or more wireless links of the second AP MLD based on the first request, wherein the second AP MLD determines whether any of the one or more TWT agreements are accepted for the one or more wireless links of the second AP MLD; and obtaining a second response, by the first AP MLD from the second AP MLD via another DS communication that indicates status for the one or more TWT agreements that were requested to be transferred in the second request, wherein providing the first response to the non-AP MLD includes the first AP MLD transmitting the first response to the non-AP MLD based on the second response.

In some aspects, the techniques described herein relate to a method, wherein the request is obtained by the second AP MLD from the non-AP MLD and the response is provided by the second AP MLD.

In some aspects, the techniques described herein relate to a method, wherein upon the request indicating wireless link identifying information for the one or more wireless links of the first AP MLD and a TWT agreement type and TWT identifier for each TWT agreement of the one or more TWT agreements or the request indicating wireless link identifying information for the one or more wireless links of the first AP MLD and a TWT agreement type identifier for each type of the one or more TWT agreements, the method further including: fetching the one or more TWT agreements from the first AP MLD by the second AP MLD as part of roaming context transfer communications between the first AP MLD and the second AP MLD.

In some aspects, the techniques described herein relate to a method, wherein the request further includes one or more TWT elements for one or more new TWT agreements requested to be set up for at least one wireless link of the second AP MLD.

In some aspects, the techniques described herein relate to a method, wherein a corresponding TWT element for each of the one or more new TWT agreements is included in a per-station profile (Per-STA Profile) subelement for the at least one wireless link of the second AP MLD where the new TWT agreements are requested to be set up.

In some aspects, the techniques described herein relate to a method, wherein the response further indicates whether any of the one or more new TWT agreements are accepted for the at least one wireless link of the second AP MLD.

In some aspects, the techniques described herein relate to a method, wherein for a particular new TWT agreement that is accepted for a particular wireless link of the second AP MLD, at least a target wake time field of a particular TWT element is updated to adjust for a time synchronization function (TSF) offset of the particular wireless link of the second AP MLD for which the particular TWT agreement is accepted.

In some aspects, the techniques described herein relate to an apparatus, including: at least one memory element for storing data; and at least one processor for executing instructions associated with the data, wherein executing the instructions causes the apparatus to perform operations, including: obtaining, from a non-access point multi-link device (non-AP MLD) that is seeking to roam from a first access point multi-link device (AP MLD) to a second AP MLD, a request to transfer one or more Target Wake Time (TWT) agreements for the non-AP MLD from one or more wireless links of the first AP MLD to one or more wireless links of the second AP MLD; determining whether any of the one or more TWT agreements are accepted for the one or more wireless links of the second AP MLD; and providing a response to the non-AP MLD indicating whether any of the one or more TWT agreements are accepted for the one or more wireless links of the second AP MLD.

In some aspects, the techniques described herein relate to an apparatus, wherein the apparatus is the first AP MLD and the request is a first request that is obtained by the first AP MLD from the non-AP MLD, wherein executing the instructions causes the apparatus to perform operations, including: transmitting, by the first AP MLD, a second request to the second AP MLD via a distribution system (DS) communication that includes one or more TWT elements for the one or more TWT agreements to be transferred to the one or more wireless links of the second AP MLD based on the first request, wherein the second AP MLD determines whether any of the one or more TWT agreements are accepted for the one or more wireless links of the second AP MLD; and obtaining the response, by the first AP MLD from the second AP MLD via another DS communication, wherein providing the response to the non-AP MLD includes the first AP MLD transmitting the response to the non-AP MLD.

In some aspects, the techniques described herein relate to an apparatus, wherein the apparatus is the second AP MLD, wherein executing the instructions causes the apparatus to perform operations, including: upon the request indicating wireless link identifying information for the one or more wireless links of the first AP MLD and a TWT agreement type and TWT identifier for each TWT agreement of the one or more TWT agreements or the request indicating wireless link identifying information for the one or more wireless links of the first AP MLD and a TWT agreement type identifier for each type of the one or more TWT agreements, fetching the one or more TWT agreements from the first AP MLD by the second AP MLD as part of roaming context transfer communications between the first AP MLD and the second AP MLD.

In some aspects, the techniques described herein relate to one or more non-transitory computer readable storage media encoded with instructions that, when executed by a processor, cause the processor to perform operations, comprising: obtaining, from a non-access point multi-link device (non-AP MLD) that is seeking to roam from a first access point multi-link device (AP MLD) to a second AP MLD, a request to transfer one or more Target Wake Time (TWT) agreements for the non-AP MLD from one or more wireless links of the first AP MLD to one or more wireless links of the second AP MLD; determining whether any of the one or more TWT agreements are accepted for the one or more wireless links of the second AP MLD; and providing a response to the non-AP MLD indicating whether any of the one or more TWT agreements are accepted for the one or more wireless links of the second AP MLD.

In some aspects, the techniques described herein relate to a computer-implemented method including: transmitting, by a non-access point multi-link device (non-AP MLD) a request to transfer one or more Target Wake Time (TWT) agreements for the non-AP MLD from one or more wireless links of a first access point multi-link device (AP MLD) to one or more wireless links of a second AP MLD; and obtaining a response indicating whether any of the one or more TWT agreements are accepted for the one or more wireless links of the second AP MLD.

In some aspects, the techniques described herein relate to a method, wherein the request is a roaming request frame, a link reconfiguration request frame, a Fast Transition (FT) request frame, or a management frame and the request corresponds to at least one of an add link operation, a switch link operation, or a delete link operation.

In some aspects, the techniques described herein relate to a method, wherein the request indicates the one or more TWT agreements that are requested to be transferred to the one or more wireless links of the second AP MLD using one of: one or two TWT elements for each TWT agreement of the one or more TWT agreements; a TWT agreement type and a TWT identifier for each TWT agreement of the one or more TWT agreements; or a TWT agreement type identifier for each type of the one or more TWT agreements.

In some aspects, the techniques described herein relate to a method, wherein the request further includes wireless link identifier (ID) information indicating at least one wireless link of the first AP MLD at which the one or more TWT that are requested to be transferred are set up.

In some aspects, the techniques described herein relate to a method, wherein the wireless link ID information, the TWT agreement type and the TWT identifier for each TWT agreement of the one or more TWT agreements, or the wireless link ID information and the TWT agreement type identifier for each type of the one or more TWT agreements are indicated in a TWT transfer information field of a station information (STA Info) field of a per-station profile (Per-STA Profile) subelement of the request.

In some aspects, the techniques described herein relate to a method, wherein the request further indicates a plurality of TWT agreements from multiple wireless links of the first AP MLD to be transferred to a particular wireless link of the second AP MLD.

In some aspects, the techniques described herein relate to a method, wherein the request further includes one or more TWT elements for one or more new TWT agreements requested to be set up for at least one wireless link of the second AP MLD.

In some aspects, the techniques described herein relate to a method, wherein the request is transmitted to the first AP MLD.

In some aspects, the techniques described herein relate to a method, wherein the request is transmitted to the second AP MLD.

In some aspects, the techniques described herein relate to one or more non-transitory computer readable storage media encoded with instructions that, when executed by a processor, cause the processor to perform operations, including: transmitting, by a non-access point multi-link device (non-AP MLD) a request to transfer one or more Target Wake Time (TWT) agreements for the non-AP MLD from one or more wireless links of a first access point multi-link device (AP MLD) to one or more wireless links of a second AP MLD; and obtaining a response indicating whether any of the one or more TWT agreements are accepted for the one or more wireless links of the second AP MLD.

In some aspects, the techniques described herein relate to an apparatus including: at least one memory element for storing data; and at least one processor for executing instructions associated with the data, wherein executing the instructions causes the apparatus to perform operations, including: transmitting, by a non-access point multi-link device (non-AP MLD) a request to transfer one or more Target Wake Time (TWT) agreements for the non-AP MLD from one or more wireless links of a first access point multi-link device (AP MLD) to one or more wireless links of a second AP MLD; and obtaining a response indicating whether any of the one or more TWT agreements are accepted for the one or more wireless links of the second AP MLD.

In some aspects, the techniques described herein may relate to a computer-implemented method is provided that may include: obtaining, from a non-AP MLD, a request to transfer one or more TWT agreements for the non-AP MLD from at least one first wireless link of an AP MLD to at least one second wireless link of the AP MLD; determining, by the AP MLD, whether any of the one or more TWT agreements (existing and/or new) are accepted for the at least one second wireless link of the AP MLD; and providing a response to the non-AP MLD indicating whether any of the one or more TWT agreements are accepted for the second wireless link of the AP MLD.

In some aspects, the request may include a request to establish one or more new TWT agreements for at least one wireless link of the AP MLD. In some aspects, the request can include a Link Reconfiguration Request frame, a Fast Transition request frame, or a management frame. In some aspects, the request can correspond to at least one of an add link operation, a switch link operation, or a delete link operation.

In some aspects, the request indicates the one or more TWT agreements that are requested to be transferred to the at least one second wireless link of the AP MLD using one of: one or two TWT elements for each TWT agreement of the one or more TWT agreements; a TWT agreement type and a TWT identifier for each TWT agreement of the one or more TWT agreements; or a TWT agreement type identifier for each type of the one or more TWT agreements. In at least one embodiment, one of the TWT agreement type and a TWT identifier for each TWT agreement of the one or more TWT agreements or the TWT agreement type identifier for each type of the one or more TWT agreements are indicated in a TWT transfer information field of a station information (STA Info) field of a per-station profile (Per-STA Profile) subelement of the request.

In some aspects, the TWT transfer information field of the STA Info field of the Per-STA Profile subelement includes one or more of: a first field that is set to indicate that all individual TWT agreements for the non-AP MLD that are set up on the first wireless link are requested to be transferred to the second wireless link; a second field that is set to indicate that all broadcast TWT agreements for the non-AP MLD that are set up on the first wireless link are requested to be transferred to the second wireless link; or a third field that is set to indicate that all restricted TWT agreements for the non-AP MLD that are set up on the first wireless link are requested to be transferred to the second wireless link. In some aspects, if the request is to delete a particular link, the response can also indicate one or more Link IDs (e.g., in the STA Info field) for the link(s) where the non-AP MLD is requesting to transfer/establish the indicated TWT agreements.

In some aspects, the TWT transfer information field of the STA Info field can include a Link ID field to explicitly indicate the link of the AP MLD where the TWT agreements indicated for transfer are currently established. In some aspects, for one or more TWT agreements for which TWT setup is successful on the at least one second wireless link, the AP MLD can indicate such by including one or more corresponding TWT elements for the one or more corresponding TWT agreements in the STA Profile field of the Per-STA Profile element of a Reconfiguration ML element or a Basic ML element. In some aspects, if the corresponding TWT agreements are established on multiple corresponding links, a Per-STA profile subelement can be provided per-link to indicate the TWT element(s) for TWT agreement(s) that were successfully established on each corresponding link.

In some aspects, the techniques described herein may relate to one or more non-transitory computer readable storage media encoded with instructions that, when executed by a processor, cause the processor to perform operations, including: obtaining, from a non-AP MLD, a request to transfer one or more TWT agreements for the non-AP MLD from at least one first wireless link of an AP MLD to at least one second wireless link of the AP MLD; determining, by the AP MLD, whether any of the one or more TWT agreements (existing and/or new) are accepted for the at least one second wireless link of the AP MLD; and providing a response to the non-AP MLD indicating whether any of the one or more TWT agreements are accepted for the second wireless link of the AP MLD.

In some aspects, the techniques described herein may relate to an apparatus including: at least one memory element for storing data; and at least one processor for executing instructions associated with the data, wherein executing the instructions causes the apparatus to perform operations, including: obtaining, from a non-AP MLD, a request to transfer one or more TWT agreements for the non-AP MLD from at least one first wireless link of an AP MLD to at least one second wireless link of the AP MLD; determining, by the AP MLD, whether any of the one or more TWT agreements (existing and/or new) are accepted for the at least one second wireless link of the AP MLD; and providing a response to the non-AP MLD indicating whether any of the one or more TWT agreements are accepted for the second wireless link of the AP MLD.

In some aspects, the techniques described herein may relate to a computer-implemented method that may include: transmitting by a non-AP MLD to an AP MLD, a request to transfer one or more TWT agreements for the non-AP MLD from at least one first wireless link of the AP MLD to at least one second wireless link of the AP MLD; and obtaining a response from the non-AP MLD indicating whether any of the one or more TWT agreements are accepted for the second wireless link of the AP MLD.

In some aspects, the request may include a request to establish one or more new TWT agreements for at least one wireless link of the AP MLD. In some aspects, the request can include a Link Reconfiguration Request frame, a Fast Transition request frame, or a management frame. In some aspects, the request can correspond to at least one of an add link operation, a switch link operation, or a delete link operation.

In some aspects, the techniques described herein may relate to one or more non-transitory computer readable storage media encoded with instructions that, when executed by a processor, cause the processor to perform operations, including: transmitting by a non-AP MLD to an AP MLD, a request to transfer one or more TWT agreements for the non-AP MLD from at least one first wireless link of the AP MLD to at least one second wireless link of the AP MLD; and obtaining a response from the non-AP MLD indicating whether any of the one or more TWT agreements are accepted for the second wireless link of the AP MLD.

In some aspects, the techniques described herein may relate to an apparatus including: at least one memory element for storing data; and at least one processor for executing instructions associated with the data, wherein executing the instructions causes the apparatus to perform operations, including: transmitting by a non-AP MLD to an AP MLD, a request to transfer one or more TWT agreements for the non-AP MLD from at least one first wireless link of the AP MLD to at least one second wireless link of the AP MLD; and obtaining a response from the non-AP MLD indicating whether any of the one or more TWT agreements are accepted for the second wireless link of the AP MLD.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi7®), IEEE 802.16 (e.g., Worldwide Interoperability for Microwave Access (WiMAX)), Radio-Frequency Identification (RFID), Near Field Communication (NFC), Bluetooth™, mm. wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

In various example implementations, any entity or apparatus for various embodiments described herein can encompass network elements (which can include virtualized network elements, functions, etc.) such as, for example, network appliances, forwarders, routers, servers, switches, gateways, bridges, loadbalancers, firewalls, processors, modules, radio receivers/transmitters, or any other suitable device, component, element, or object operable to exchange information that facilitates or otherwise helps to facilitate various operations in a network environment as described for various embodiments herein. Note that with the examples provided herein, interaction may be described in terms of one, two, three, or four entities. However, this has been done for purposes of clarity, simplicity and example only. The examples provided should not limit the scope or inhibit the broad teachings of systems, networks, etc. described herein as potentially applied to a myriad of other architectures.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and, in the claims, can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, service, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Each example embodiment disclosed herein has been included to present one or more different features. However, all disclosed example embodiments are designed to work together as part of a single larger system or method. This disclosure explicitly envisions compound embodiments that combine multiple previously discussed features in different example embodiments into a single system or method.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’ nomenclature (e.g., one or more element(s)).

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. A method comprising:
obtaining, from a non-access point multi-link device (non-AP MLD) that is seeking to roam from a first access point multi-link device (AP MLD) to a second AP MLD, a request to transfer one or more Target Wake Time (TWT) agreements for the non-AP MLD from one or more wireless links of the first AP MLD to one or more wireless links of the second AP MLD;
determining whether any of the one or more TWT agreements are accepted for the one or more wireless links of the second AP MLD; and
providing a response to the non-AP MLD indicating whether any of the one or more TWT agreements are accepted for the one or more wireless links of the second AP MLD.

2. The method of claim 1, wherein the request is a roaming request frame, a link reconfiguration request frame, a Fast Transition (FT) request frame, or a management frame.

3. The method of claim 2, wherein the request corresponds to at least one of an add link operation, a switch link operation, or a delete link operation.

4. The method of claim 1, wherein the request indicates the one or more TWT agreements that are requested to be transferred to the one or more wireless links of the second AP MLD using one of:
one or two TWT elements for each TWT agreement of the one or more TWT agreements;
a TWT agreement type and a TWT identifier for each TWT agreement of the one or more TWT agreements; or
a TWT agreement type identifier for each type of the one or more TWT agreements.

5. The method of claim 4, wherein the request further indicates wireless link identifier (ID) information indicating at least one wireless link of the first AP MLD at which the one or more TWT agreements that are requested to be transferred are set up.

6. The method of claim 5, wherein the wireless link ID information, the TWT agreement type and the TWT identifier for each TWT agreement of the one or more TWT agreements or the wireless link ID information and the TWT agreement type identifier for each type of the one or more TWT agreements are indicated in a TWT transfer information field of a station information (STA Info) field of a per-station profile (Per-STA Profile) subelement of the request.

7. The method of claim 6, wherein the TWT transfer information field of the STA Info field of the Per-STA Profile subelement includes one or more of:
a first field that is set to indicate that all individual TWT agreements for the non-AP MLD that are set up on a particular wireless link of the first AP MLD are requested to be transferred;
a second field that is set to indicate that all broadcast TWT agreements for the non-AP MLD that are set up on a particular wireless link of the first AP MLD are requested to be transferred; or
a third field that is set to indicate that all restricted TWT agreements for the non-AP MLD that are set up on a particular wireless link of the first AP MLD are requested to be transferred.

8. The method of claim 1, wherein the request further indicates a plurality of TWT agreements from multiple wireless links of the first AP MLD to be transferred to a particular wireless link of the second AP MLD.

9. The method of claim 1, wherein the response is a roaming response frame, a link reconfiguration response frame, a Fast Transition (FT) response frame, or a management frame.

10. The method of claim 1 wherein, for a particular TWT agreement that is accepted for a particular wireless link of the second AP MLD, the response includes a TWT element for the particular TWT agreement that is accepted.

11. The method of claim 10, wherein the TWT element is provided in a per-station profile (Per-STA Profile) subelement of the response.

12. The method of claim 10, wherein, for the particular TWT agreement that is accepted for the wireless link of the second AP MLD, at least a target wake time field of the TWT element is updated to adjust for a time synchronization function (TSF) offset of the particular wireless link of the second AP MLD for which the particular TWT agreement is accepted.

13. The method of claim 1, wherein the response further indicates one or more of:
at least one counter proposal TWT agreement for at least one TWT agreement that is not accepted for the one or more wireless links; or
at least one new TWT agreement that is capable of being accepted for the one or more wireless links by the second AP MLD.

14. The method of claim 1, wherein the request is a first request that is obtained by the first AP MLD from the non-AP MLD and the response is a first response that is provided to the non-AP MLD, the method further comprising:
transmitting, by the first AP MLD, a second request to the second AP MLD via a distribution system (DS) communication that includes one or more TWT elements for the one or more TWT agreements to be transferred to the one or more wireless links of the second AP MLD based on the first request, wherein the second AP MLD determines whether any of the one or more TWT agreements are accepted for the one or more wireless links of the second AP MLD; and
obtaining a second response, by the first AP MLD from the second AP MLD via another DS communication that indicates status for the one or more TWT agreements that were requested to be transferred in the second request, wherein providing the first response to the non-AP MLD includes the first AP MLD transmitting the first response to the non-AP MLD based on the second response.

15. The method of claim 1, wherein the request is obtained by the second AP MLD from the non-AP MLD and the response is provided by the second AP MLD.

16. The method of claim 15, wherein upon the request indicating wireless link identifying information for the one or more wireless links of the first AP MLD and a TWT agreement type and TWT identifier for each TWT agreement of the one or more TWT agreements or the request indicating wireless link identifying information for the one or more wireless links of the first AP MLD and a TWT agreement type identifier for each type of the one or more TWT agreements, the method further comprising:
fetching the one or more TWT agreements from the first AP MLD by the second AP MLD as part of roaming context transfer communications between the first AP MLD and the second AP MLD.

17. The method of claim 1, wherein the request further includes one or more TWT elements for one or more new TWT agreements requested to be set up for at least one wireless link of the second AP MLD.

18. The method of claim 17, wherein a corresponding TWT element for each of the one or more new TWT agreements is included in a per-station profile (Per-STA Profile) subelement for the at least one wireless link of the second AP MLD where the one or more new TWT agreements are requested to be set up.

19. The method of claim 17, wherein the response further indicates whether any of the one or more new TWT agreements are accepted for the at least one wireless link of the second AP MLD.

20. The method of claim 19, wherein for a particular new TWT agreement that is accepted for a particular wireless link of the second AP MLD, at least a target wake time field of a particular TWT element is updated to adjust for a time synchronization function (TSF) offset of the particular wireless link of the second AP MLD for which the particular new TWT agreement is accepted.

21. An apparatus, comprising:
at least one memory element for storing data; and
at least one processor for executing instructions associated with the data, wherein executing the instructions causes the apparatus to perform operations, comprising:
obtaining, from a non-access point multi-link device (non-AP MLD) that is seeking to roam from a first access point multi-link device (AP MLD) to a second AP MLD, a request to transfer one or more Target Wake Time (TWT) agreements for the non-AP MLD from one or more wireless links of the first AP MLD to one or more wireless links of the second AP MLD;
determining whether any of the one or more TWT agreements are accepted for the one or more wireless links of the second AP MLD; and
providing a response to the non-AP MLD indicating whether any of the one or more TWT agreements are accepted for the one or more wireless links of the second AP MLD.

22. The apparatus of claim 21, wherein the apparatus is the first AP MLD and the request is a first request that is obtained by the first AP MLD from the non-AP MLD, wherein executing the instructions causes the apparatus to perform operations, comprising:
transmitting, by the first AP MLD, a second request to the second AP MLD via a distribution system (DS) communication that includes one or more TWT elements for the one or more TWT agreements to be transferred to the one or more wireless links of the second AP MLD based on the first request, wherein the second AP MLD determines whether any of the one or more TWT agreements are accepted for the one or more wireless links of the second AP MLD; and
obtaining the response, by the first AP MLD from the second AP MLD via another DS communication, wherein providing the response to the non-AP MLD includes the first AP MLD transmitting the response to the non-AP MLD.

23. The apparatus of claim 21, wherein the apparatus is the second AP MLD, wherein executing the instructions causes the apparatus to perform operations, comprising:
upon the request indicating wireless link identifying information for the one or more wireless links of the first AP MLD and a TWT agreement type and TWT identifier for each TWT agreement of the one or more TWT agreements or the request indicating wireless link identifying information for the one or more wireless links of the first AP MLD and a TWT agreement type identifier for each type of the one or more TWT agreements, fetching the one or more TWT agreements from the first AP MLD by the second AP MLD as part of roaming context transfer communications between the first AP MLD and the second AP MLD.

24. A method comprising:
transmitting, by a non-access point multi-link device (non-AP MLD) a request to transfer one or more Target Wake Time (TWT) agreements for the non-AP MLD from one or more wireless links of a first access point multi-link device (AP MLD) to one or more wireless links of a second AP MLD; and
obtaining a response indicating whether any of the one or more TWT agreements are accepted for the one or more wireless links of the second AP MLD.

25. The method of claim 24, wherein the request is a roaming request frame, a link reconfiguration request frame, a Fast Transition (FT) request frame, or a management frame and the request corresponds to at least one of an add link operation, a switch link operation, or a delete link operation.

26. The method of claim 24, wherein the request indicates the one or more TWT agreements that are requested to be transferred to the one or more wireless links of the second AP MLD using one of:
one or two TWT elements for each TWT agreement of the one or more TWT agreements;
a TWT agreement type and a TWT identifier for each TWT agreement of the one or more TWT agreements; or
a TWT agreement type identifier for each type of the one or more TWT agreements.

27. The method of claim 26, wherein the request further includes wireless link identifier (ID) information indicating at least one wireless link of the first AP MLD at which the one or more TWT that are requested to be transferred are set up.

28. The method of claim 27, the wireless link ID information, the TWT agreement type and the TWT identifier for each TWT agreement of the one or more TWT agreements, or the wireless link ID information and the TWT agreement type identifier for each type of the one or more TWT agreements are indicated in a TWT transfer information field of a station information (STA Info) field of a per-station profile (Per-STA Profile) subelement of the request.

29. The method of claim 24, wherein the request further indicates a plurality of TWT agreements from multiple wireless links of the first AP MLD to be transferred to a particular wireless link of the second AP MLD.

30. The method of claim 24, wherein the request further includes one or more TWT elements for one or more new TWT agreements requested to be set up for at least one wireless link of the second AP MLD.

31. The method of claim 24, wherein the request is transmitted to the first AP MLD.

32. The method of claim 24, wherein the request is transmitted to the second AP MLD.
